(19) United States
(12) Patent Application Publication
(10) Pub. No.: US 2009/0237689 A1
(43) Pub. Date: Sep. 24, 2009

(54) Concentration correcting method

(75) Inventors: Michiaki Tokunaga, Matsumoto-shi (JP); Masahiko Yoshida, Shiojiri-shi (JP); Tatsuya Nakano, Nagano-ken (JP); Takeshi Yoshida, Shiojiri-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/383,415

(22) Filed: Mar. 24, 2009

(30) Foreign Application Priority Data
Mar. 24, 2008 (JP) 2008-076443

(51) Int. Cl. H04N 1/60

(52) U.S. Cl. 358/1.9

(57) ABSTRACT

A concentration correcting method includes: forming N test patterns at different positions in a moving direction by repeatedly performing a dot line forming process of forming a dot line in a line region on a test medium in which a plurality of unit areas is arranged in the moving direction by ejecting liquid from nozzles direction and a transport process of transporting the test medium in a transport direction; performing on the N test patterns a process of calculating a concentration correction value, which is used to correct concentrations of the unit areas in a print image; and correcting the concentrations of the unit areas in the print image by the use of interpolated correction values obtained using a linear interpolation method, two concentration correcting values acquired from the two test patterns, and positions of the unit areas in the moving direction.

### BACKGROUND

1. Technical Field

The present invention relates to a concentration correcting method, and more particularly, to a method of correcting a concentration of a unit area in a print image.

2. Related Art

For example, an ink jet printer was known as a printing apparatus transporting a medium (such as a sheet of paper or cloth) in a transport direction and performing a printing operation on the medium by the use of a head. When unevenness in concentration (for example, a white line or a black line) is generated in the print image at the time of performing a printing operation by the use of such a printing apparatus, image quality of the print image is deteriorated. Therefore, a method of correcting a concentration of a unit area (pixel) in the print image on the basis of a concentration correction value acquired every dot line (raster line) was suggested as a method for solving the above-mentioned problem.

A method of forming a test pattern on a test medium and calculating the concentration correction value every line region on the basis of the test pattern was invented as the method of acquiring the concentration correction value used to correct the concentration of the unit area in the print image.

An example of the above-mentioned related art is described in JP-A-2-54676.

When the above-mentioned ink jet printer is a so-called serial printer, a test pattern is formed by repeatedly performing a dot line forming process of forming dot lines in line regions on a test medium in which plural unit areas are arranged in a moving direction by ejecting liquid from nozzles while allowing the nozzles to move in the moving direction and a transport process of transporting the test medium in a transport direction. The concentrations of the unit areas in the print image printed on a printing medium by repeatedly performing the dot line forming process and the transport process are corrected on the basis of the concentration correction value acquired from the test pattern.

When the correction of concentration is performed in this way, the concentration might not be accurately corrected. Accordingly, there is a need for a method of accurately correcting a concentration.

### SUMMARY

An advantage of some aspects of the invention is to accurately correct a concentration.

According to an aspect of the invention, there is provided a concentration correcting method including: forming N test patterns at different positions in a moving direction by repeatedly performing a dot line forming process of forming a dot line in a line region on a test medium in which a plurality of unit areas is arranged in the moving direction by ejecting liquid from nozzles while allowing the nozzles to move in the moving direction and a transport process of transporting the test medium in a transport direction; performing on the N test patterns a process of calculating a concentration correction value, which is used to correct concentrations of the unit areas in a print image to be printed on a printing medium by repeatedly performing the dot line forming process and the transport process, every line region on the basis of the corresponding test pattern and acquiring N concentration correction values corresponding to each line region; and correcting the concentrations of the unit areas in the print image by the use of interpolated correction values obtained using a linear interpolation method on the basis of positions of two test patterns of the N test patterns in the moving direction, two concentration correcting values acquired from the two test patterns, and positions of the unit areas in the moving direction.

Other features of the invention will become apparent from the specification and the accompanying drawing.

### BRIEF DESCRIPTION OF THE DRAWINGS

The invention will be described with reference to the accompanying drawings, wherein like numbers reference like elements.

FIG. 1 is a diagram illustrating an appearance of a printing system.

FIG. 2 is a block diagram illustrating the entire configuration of a printer.

FIG. 3A is a diagram schematically illustrating the entire configuration of the printer and FIG. 3B is a sectional view illustrating the entire configuration of the printer.

FIG. 4 is a diagram illustrating an arrangement of nozzles on a bottom surface of a head.

FIGS. 5A and 5B are diagrams illustrating a normal printing operation.

FIG. 6 is a diagram illustrating a leading-edge printing operation and a trailing-edge printing operation.

FIG. 7A is a sectional view illustrating a scanner and FIG. 7B is a top view of the scanner where an upper cover is removed.

FIG. 8A is a diagram illustrating a state where dots are ideally formed, FIG. 8B is a diagram illustrating unevenness in concentration, and FIG. 8C is a diagram illustrating a state where dots are formed by correcting the unevenness in concentration.

FIG. 9 is a diagram illustrating a state where a position of the head relative to a sheet is changed when the head of the printer moves in the moving direction relative to the sheet.

FIG. 10 is a graph illustrating an error of a reading position of the scanner.

FIG. 11A is a diagram illustrating a relation between an original document and image data when the reading position of the scanner is accurate and FIG. 11B is a diagram illustrating a relation between the original document and the image data when the reading position of the scanner includes an error.

FIG. 12 is a flow diagram illustrating an entire flow of an embodiment.

FIG. 13 is a flow diagram illustrating the entire flow of the embodiment.

FIG. 14 is a diagram illustrating a jig mounted on the scanner.

FIG. 15A is a diagram illustrating the jig mounted on the scanner as viewed in a sub scanning direction.

FIG. 15B is a diagram illustrating the jig mounted on the scanner as viewed from the upside.

FIG. 16 is a diagram illustrating a reference sheet.

FIG. 17 is a flow diagram illustrating a line position calculating process of a reference pattern.

FIG. 18 is a graph illustrating one-dimensional image data.

FIG. 19A is a diagram illustrating pixel data in a calculation range and FIG. 19B is a diagram illustrating the pixel data after normalization.

FIG. 20 is a flow diagram illustrating a BRS correction value calculating process.

FIG. 21 is a diagram schematically illustrating a state where a test pattern is formed on a test sheet.

FIG. 22 is a diagram illustrating the test pattern.

FIG. 23A is a diagram illustrating the pixel data before correction.

FIG. 23B is a diagram illustrating a method of calculating the pixel data corresponding to a concentration-calculation position.

FIG. 23C is a diagram illustrating the method of calculating the pixel data corresponding to a concentration-calculation position.

FIG. 24 is a table of acquired values in which concentration acquisition results of five kinds of band-like patterns of cyan are arranged.

FIG. 25 is a graph illustrating the acquired values of the band-like patterns with a cyan concentration of 30%, a cyan concentration of 40%, and a cyan concentration of 50%.

FIG. 26A is a diagram illustrating a target instructed gray-scale value with respect to an instructed gray-scale value in a line region and FIG. 26B is a diagram illustrating the target instructed gray-scale value with respect to the instructed gray-scale value in another line region.

FIG. 27 is a diagram illustrating a BRS correction value table of cyan.

FIG. 28 is a diagram illustrating a moving-direction position table of cyan.

FIG. 29 is a flow diagram illustrating a concentration correcting process according to a first embodiment of the invention.

FIG. 30 is a diagram illustrating an interpolated correction value calculating process.

FIG. 31 is a diagram illustrating a gray-scale value correcting process.

FIG. 32 is a diagram illustrating a concentration correcting process according to a second embodiment of the invention.

FIG. 33 is a diagram illustrating a concentration correcting process according to a modified example of the first embodiment of the invention.

FIG. 34 is a diagram illustrating a concentration correcting process according to a modified example of the second embodiment of the invention.

### DESCRIPTION OF EXEMPLARY EMBODIMENTS

The following description will be apparently understood from the specification and the accompanying drawings.

A concentration correcting method may include: forming N test patterns at different positions in a moving direction by repeatedly performing a dot line forming process of forming a dot line in a line region on a test medium in which a plurality of unit areas is arranged in the moving direction by ejecting liquid from nozzles while allowing the nozzles to move in the moving direction and a transport process of transporting the test medium in a transport direction; performing on the N test patterns a process of calculating a concentration correction value, which is used to correct concentrations of the unit areas in a print image to be printed on a printing medium by repeatedly performing the dot line forming process and the transport process, every line region on the basis of the corresponding test pattern and acquiring N concentration correction values corresponding to each line region; and correcting the concentrations of the unit areas in the print image by the use of interpolated correction values obtained using a linear interpolation method on the basis of positions of two test patterns of the N test patterns in the moving direction, two concentration correcting values acquired from the two test patterns, and positions of the unit areas in the moving direction.

According to this concentration correcting method, it is possible to accurately correct the concentrations.

A concentration correcting method may include: forming N test patterns at different positions in a moving direction by repeatedly performing a dot line forming process of forming a dot line in a line region on a test medium in which a plurality of unit areas is arranged in the moving direction by ejecting liquid from nozzles while allowing the nozzles to move in the moving direction and a transport process of transporting the test medium in a transport direction; performing on the N test patterns a process of calculating a concentration correction value, which is used to correct concentrations of the unit areas in a print image to be printed on a printing medium by repeatedly performing the dot line forming process and the transport process, every line region on the basis of the corresponding test pattern and acquiring N concentration correction values corresponding to each line region; and correcting the concentrations of the unit areas in the print image by the use of the concentration correction value obtained from the test pattern having the smallest distance to the positions of the unit areas in the moving direction among the N concentration correction values.

According to this concentration correcting method, it is possible to accurately correct the concentrations.

The N test patterns may include three test patterns of a first test pattern formed at one end in the moving direction, a second test pattern formed at a center position in the moving direction, and a third test pattern formed at the other end in the moving direction, and the correcting of the concentrations may include performing a process of correcting the concentrations of the unit areas in the print image on all the unit areas of the print image.

According to this configuration, it is possible to accurately correct the concentrations of all the unit areas of the print image.

The correcting of the concentrations may include: performing a process of correcting the concentrations of the unit areas in the print image using the interpolated correction values on some unit areas of the print image; and correcting the concentrations of the other unit areas of the print image by the use of one of the N concentration correction values.

According to this configuration, it is possible to accurately, simply, and easily correct the concentrations.

The N test patterns may include two test patterns of a first test pattern formed at one end in the moving direction and a second test pattern formed at a center position in the moving direction, and the correcting of the concentrations may include: performing a process of correcting the concentrations of the unit areas in the print image by the use of the concentration correction values, which are obtained from the test pattern having the smallest distance to the positions of the unit areas in the moving direction, on the unit areas located closer to one end in the moving direction than the center position of the print image; and correcting the concentrations of the unit areas located closer to the other end in the moving direction than the center position of the print image by the use of the concentration correction values obtained from the second test pattern.

According to this configuration, it is possible to accurately, simply, and easily correct the concentrations.

There is provided a printing apparatus storing a concentration correction value which is obtained by: forming N test patterns at different positions in a moving direction by repeatedly performing a dot line forming process of forming a dot line in a line region on a test medium in which a plurality of unit areas is arranged in the moving direction by ejecting liquid from nozzles while allowing the nozzles to move in the moving direction and a transport process of transporting the test medium in a transport direction; and performing on the N test patterns a process of calculating a concentration correction value, which is used to correct concentrations of the unit areas in a print image to be printed on a printing medium by repeatedly performing the dot line forming process and the transport process, every line region on the basis of the corresponding test pattern and acquiring N concentration correction values corresponding to each line region, wherein the printing apparatus corrects the concentrations of the unit areas in the print image by the use of interpolated correction values obtained using a linear interpolation method on the basis of positions of two test patterns of the N test patterns in the moving direction, two concentration correcting values acquired from the two test patterns, and positions of the unit areas in the moving direction and prints the corrected print image on the printing medium.

According to this printing apparatus, it is possible to accurately correct the concentration.

### Printing System

### Entire Configuration

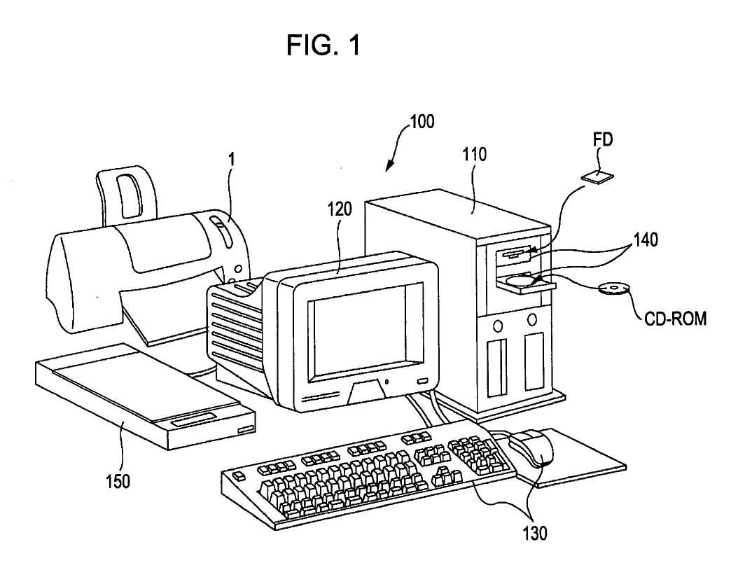

FIG. 1 is a diagram illustrating an appearance of a printing system. The printing system 100 includes a printer 1, a computer 110, a display device 120, an input unit 130, a recording and reproducing apparatus 140, and a scanner 150. The printer 1 is a printing apparatus printing an image on a medium such as a sheet of paper, a sheet of cloth, and a film. The computer 110 is connected to the printer 1 to communicate therewith and outputs print data corresponding to an image to be printed to the printer 1 so as to allow the printer 1 to print the image.

A printer driver is installed in the computer 110. The printer driver is a program for displaying a user interface on the display device 120 and converting image data output from an application program into print data. The printer driver is stored in a recording medium (computer-readable recording medium) such as a flexible disc (FD) or a CD-ROM. Alternatively, the printer driver may be downloaded to the computer 110 via the Internet. The program includes codes for embodying various functions.

### Configuration of Printer

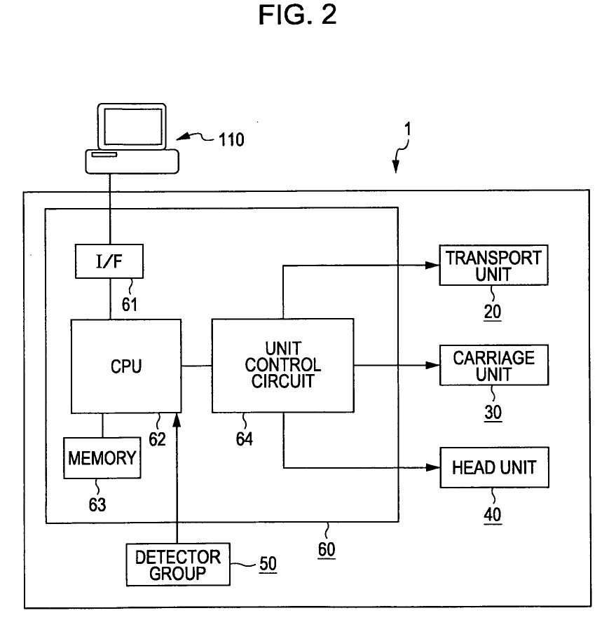

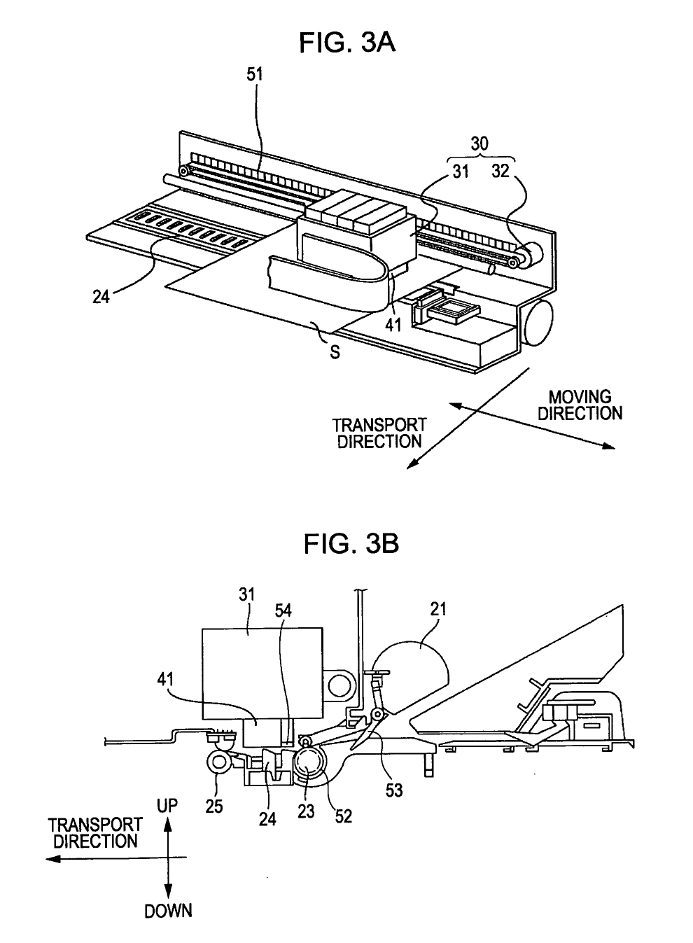

FIG. 2 is a block diagram illustrating the entire configuration of the printer 1. FIG. 3A is a diagram schematically illustrating the entire configuration of the printer 1. FIG. 3B is a sectional view illustrating the entire configuration of the printer 1.

The printer 1 includes a transport unit 20, a carriage unit 30, a head unit 40, a detector group 50, and a controller 60. The printer 1 receiving the print data from the computer 110 as an external device controls the units (such as the transport unit 20, the carriage unit 30, and the head unit 40) by the use of the controller 60. The controller 60 controls the units to print an image on a sheet of paper on the basis of the print data received from the computer 110. The situation in the printer 1 is monitored by the detector group 50 and the detector group 50 outputs the detection results to the controller 60. The controller 60 controls the units on the basis of the detection results output from the detector group 50.

The transport unit 20 serves to transport a medium (such as a sheet of paper S) in a transport direction. The transport unit 20 includes a feed roller 21, a transport motor (not shown), a transport roller 23, a platen 24, and a discharge roller 25. The feed roller 21 is a roller feeding the sheet inserted into a sheet insertion port to the inside of the printer. The transport roller 23 is a roller transporting the sheet S fed by the feed roller 21 to a printing region and is driven by the transport roller. The platen 24 supports the sheet S in print. The discharge roller 25 is a roller discharging the sheet S to the outside of the printer and is disposed downstream in the transport direction from the printing region. The discharge roller 25 rotates in synchronization with the transport roller 23.

When the transport roller 23 transports the sheet S, the sheet S is nipped between the transport roller 23 and a driven roller. Accordingly, the posture of the sheet S is stabilized. On the other hand, when the discharge roller 25 transports the sheet S, the sheet S is nipped between the discharge roller 25 and a driven roller.

The carriage unit 30 serves to move (also referred to as “scan”) the head in the moving direction. The carriage unit 30 includes a carriage 31 and a carriage motor 32. The carriage 31 can reciprocate in the moving direction and is driven by the carriage motor 32. The carriage 31 detachably receives an ink cartridge containing ink.

The head unit 40 serves to eject ink to the sheet. The head unit 40 includes a head 41 having plural nozzles. The head 41 is disposed in the carriage 31. Accordingly, when the carriage 31 moves in the moving direction, the head 41 also moves in the moving direction. The head 41 (the nozzles disposed in the head 41) intermittently ejects ink in the course of moving in the moving direction, whereby dot lines (raster lines) along the moving direction are formed on the sheet.

The detector group 50 includes a linear encoder 51, a rotary encoder 52, a sheet detecting sensor 53, and an optical sensor 54. The linear encoder 51 detects the position of the carriage 31 in the moving direction. The rotary encoder 52 detects the rotating angle of the transport roller 23. The sheet detecting sensor 53 detects the position of the leading edge of the sheet in feed. The optical sensor 54 detects the presence of the sheet by the use of a light-emitting portion and a light-receiving portion disposed in the carriage 31. The optical sensor 54 can detect the position of the ends of the sheet and detect the width of the sheet while moving with the carriage 31. The optical sensor 54 can detect the leading edge (which is an edge downstream in the transport direction and is also referred to as “upper edge”) and the trailing edge (which is an edge upstream in the transport direction and is also referred to as “lower edge”) of the sheet in some cases.

The controller 60 is a control unit controlling the printer. The controller 60 includes an interface unit 61, a CPU 62, a memory 63, and a unit control circuit 64. The interface unit 61 transmits and receives data between the computer 110 as an external device and the printer 1. The CPU 62 is a computing unit controlling the entire operation of the printer. The memory 63 serves to secure an area storing programs of the CPU 62 or a work area and includes memory elements such as a RAM and an EEPROM. The CPU 62 controls the units by the use of the unit control circuit 64 in accordance with the programs stored in the memory 63.

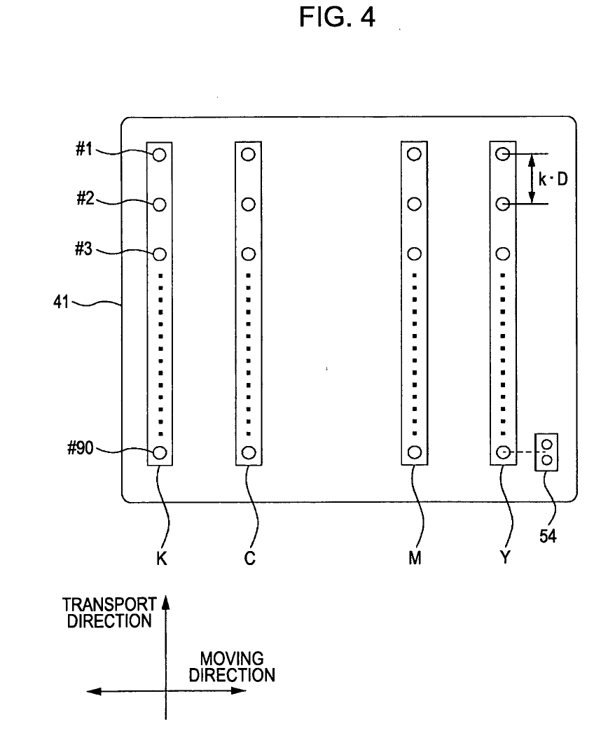

FIG. 4 is a diagram illustrating an arrangement of nozzles in the bottom surface of the head 41. A black ink nozzle group K, a cyan ink nozzle group C, a magenta ink nozzle group M, and a yellow ink nozzle group Y are formed in the bottom surface of the head 41. The respective nozzle groups include ninety nozzles which are ejection holes for ejecting the ink of colors and are arranged in the transport direction.

The plural nozzles of the respective nozzle groups are arranged in the transport direction with an equal interval (nozzle pitch: k·D). Here, D represents the minimum dot pitch (that is, the interval at the highest resolution of dots formed on the sheet S) in the transport direction. k is an integer of 1 or more. For example, when the nozzle pitch is 90 dpi ( 1/90 inch) and the dot pitch in the transport direction is 360 dpi ( 1/360 inch), k=4.

In each nozzle group, the smaller number is given to the nozzle located more downstream (#1 to #90). That is, nozzle #1 is located more downstream in the transport direction than nozzle #90. The optical sensor 54 is located almost at the same position as nozzle #90 located the most downstream in the sheet transport direction.

Each nozzle is provided with an ink chamber (not shown) and a piezoelectric element. The ink chamber is expanded and contracted by the driving of the piezoelectric element, thereby ejecting ink droplets from the nozzle.

### Printing Operation of Printer

The printer 1 repeatedly performs a dot line forming process of forming dot lines on a sheet by ejecting ink from the nozzles while allowing the head 41 having the nozzles to move in the moving direction and a transport process of transporting the sheet S in the transport direction by the use of the transport unit 20 at the time of performing a printing operation on the sheet S. In the dot line forming process, the ink is intermittently ejected from the nozzles to form the dot lines including plural dots in the moving direction. The dot lines are also referred to as “raster lines.”

A normal printing operation is first described. The normal printing operation is performed using a printing method called an interlace print. Here, the “interlace print” means a printing operation of interposing a raster line not printed between raster lines printed in one pass. The “pass” means a dot forming operation and “pass n” in the following description means a n-th dot forming operation.

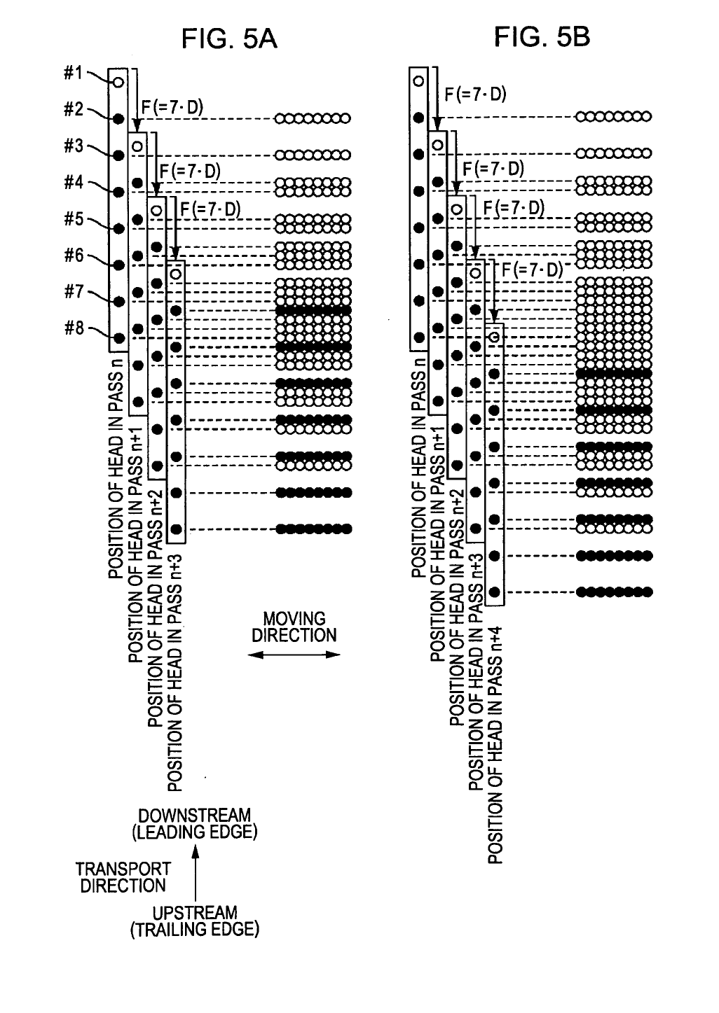

FIGS. 5A and 5B are diagrams illustrating the normal printing operation. FIG. 5A shows the positions of the head and the formed dots in pass n to pass n+3 and FIG. 5B shows the positions of the head and the formed dots in pass n to pass n+4.

For the purpose of convenient explanation, only one nozzle group is shown among plural nozzle groups and the number of nozzles is reduced. Although it is shown that the head 41 (or the nozzle group) moves relative to the sheet, the drawing shows the relative position of the head 41 and the sheet and actually, the sheet moves in the transport direction. For the purpose of convenient explanation, it is shown that each nozzle forms only several dots (round marks in the drawing). However, since ink droplets are intermittently ejected from the nozzles moving in the moving direction, plural dots are arranged in the moving direction (where the line of dots is a raster line). Of course, no dot may be formed depending on pixel data.

In the drawing, the nozzle indicated by a black round mark is a nozzle capable of ejecting ink and the nozzle indicated by a white round mark is a nozzle capable of not ejecting ink. In the drawing, the dot indicated by a black round mark is a dot formed in the final pass and the dot indicated by a white round mark is a dot formed in the previous pass.

In this interlace printing operation, the nozzles print the raster line just above the raster line printed in the previous pass whenever the sheet is transported by a constant transport distance F in the transport direction. To perform the printing operation with the constant transport distance, conditions (1) that the number of nozzles N (integer) capable of ejecting ink is co-prime to k and (2) that the transport distance F is set to N·D should be satisfied. Here, N=7, k=4, and F=7·D (where D= 1/360 inch).

However, in only the normal printing operation, positions where the raster lines cannot be formed continuously in the transport direction exist. Therefore, printing operations called a leading-edge printing operation and a trailing-edge printing operation are performed before and after the normal printing operation.

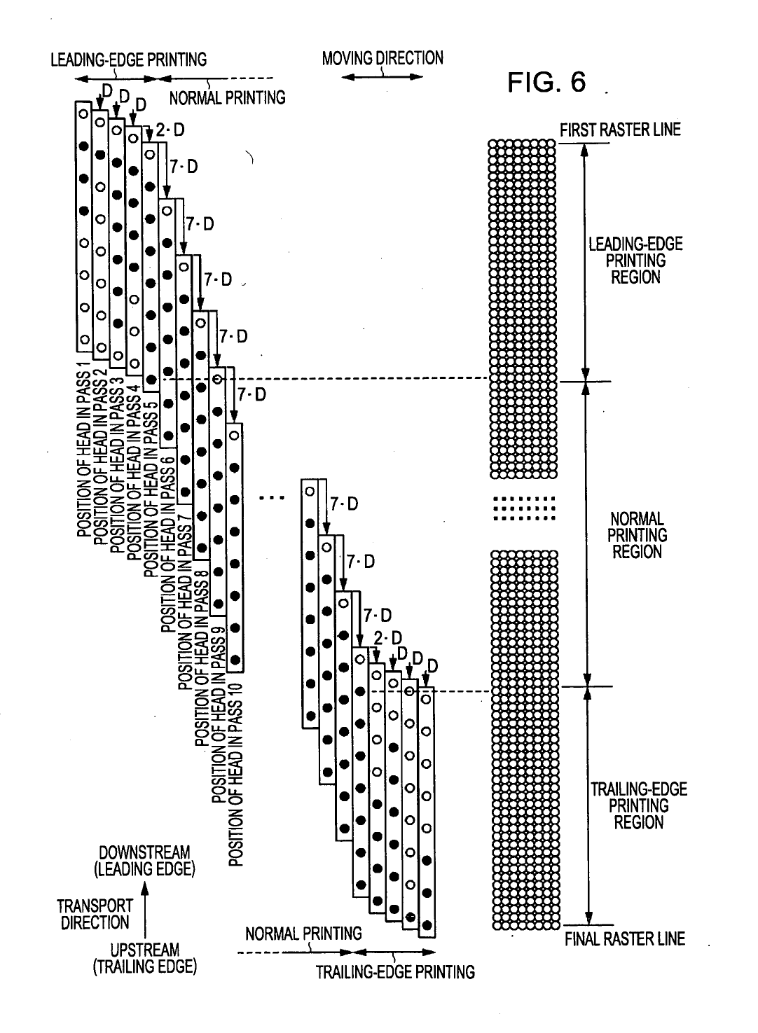

FIG. 6 is a diagram illustrating the leading-edge printing operation and the trailing-edge printing operation. The leading-edge printing operation is performed in the first five passes and the trailing-edge printing operation is performed in the final five passes.

In the leading-edge printing operation, when the vicinity of the leading edge of a print image is printed, the sheet is transported by a transport distance (1·D or 2·D) smaller than the transport distance (7·D) of the normal printing operation. In the leading-edge printing operation, the nozzles ejecting ink are not constant. In the trailing-edge printing operation, similarly to the leading-edge printing operation, when the vicinity of the trailing edge of the print image is printed, the sheet is transported by a transport distance (1·D or 2·D) smaller than the transport distance (7·D) of the normal printing operation. In the trailing-edge printing operation, the nozzles ejecting ink are not constant. Accordingly, plural raster lines arranged continuously in the transport direction can be formed between the first raster line to the final raster line.

A region in which the raster lines are formed in only the normal printing operation is referred to as a “normal printing region.” A region located closer to the leading edge of the sheet (more downstream in the transport direction) than the normal printing region is referred to as a “leading-edge printing region.” A region located closer to the trailing edge of the sheet (more downstream in the transport direction) than the normal printing region is referred to as a “trailing-edge printing region.” Thirty raster lines are formed in the leading-edge printing region. Similarly, thirty raster lines are formed in the trailing-edge printing region. On the contrary, about several thousands of raster lines are formed in the normal printing region, depending on the size of the sheet.

The arrangement of the raster lines in the normal printing region has regularity by the number of (seven in this example) raster lines corresponding to the transport distance. The first to seventh raster lines in the normal printing region of FIG. 6 are formed by nozzle #3, nozzle #5, nozzle #7, nozzle #2, nozzle #4, nozzle #6, and nozzle #8, respectively, and seven raster lines from the eighth raster line are formed by the nozzles in this order.

On the other hand, it is difficult to find out the regularity from the arrangement of the raster lines in the leading-edge printing region and the trailing-edge printing region, compared with the raster lines in the normal printing region.

### Configuration of Scanner

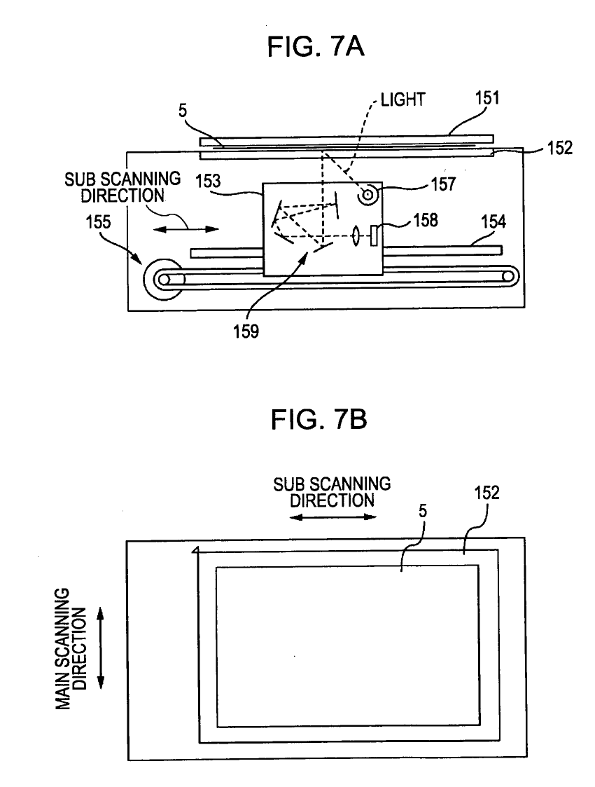

FIG. 7A is a sectional view of the scanner 150. FIG. 7B is a top view of the scanner 150 where the upper cover 151 is removed.

The scanner 150 includes an upper cover 151, a platen glass 152 on which an original document 5 is placed, a reading carriage 153 moving in a sub scanning direction while facing the original document 5 with the platen glass 152 interposed therebetween, a guide section 154 guiding the reading carriage 153 in the sub scanning direction, a moving mechanism 155 allowing the reading carriage 153 to move, and a scanner controller (not shown) controlling the units of the scanner 150. The reading carriage 153 is provided with an exposure lamp 157 emitting light to the original document 5, a line sensor 158 detecting a line image in a main scanning direction (direction perpendicular to the paper surface of FIG. 7A), and an optical system 159 guiding the light reflected from the original document 5 to the line sensor 158. The broken line in the reading carriage 153 in the drawing indicates a trace of light.

### Unevenness in Concentration (Banding)

Unevenness in concentration is generated at the time of allowing the printer to perform a printing operation. Here, for the purpose of convenient explanation, a reason of the unevenness in concentration generated in a monochromatic printed image will be described now. In multicolored printing, the reason of generation of the unevenness in concentration to be described below exists for each color.

### Unevenness in Concentration Due to Nozzles

In the following description, a “unit area” means a rectangular area virtually determined on a medium such as a sheet of paper and the size or shape thereof is determined depending on a print resolution. For example, when the print resolution is 360 dpi (in the moving direction)×360 dpi (in the transport direction), the unit area is a square area having, for example, a size of 70.56 μm×70.56 μm (≈ 1/360 inch× 1/360 inch). When an ink droplet is ejected ideally, an ink droplet is landed on the center position of the unit area and then the ink droplet is diffused on the medium to form a dot in the unit area. One pixel of image data corresponds to one unit area. Since pixels correspond to the unit areas, the pixel data of the pixels correspond to the unit areas.

In the following description, the “line region” means a region including plural unit areas arranged in the moving direction, that is, a region in which plural unit areas are arranged in the moving direction. For example, when the print resolution is 360 dpi×360 dpi, the line region is a band-like region having a width of 70.56 μm (≈ 1/360 inch) in the transport direction. When ink droplets are intermittently ejected ideally from the nozzles moving in the moving direction, a raster line is formed in the line region. The line region corresponds to plural pixels arranged in the moving direction.

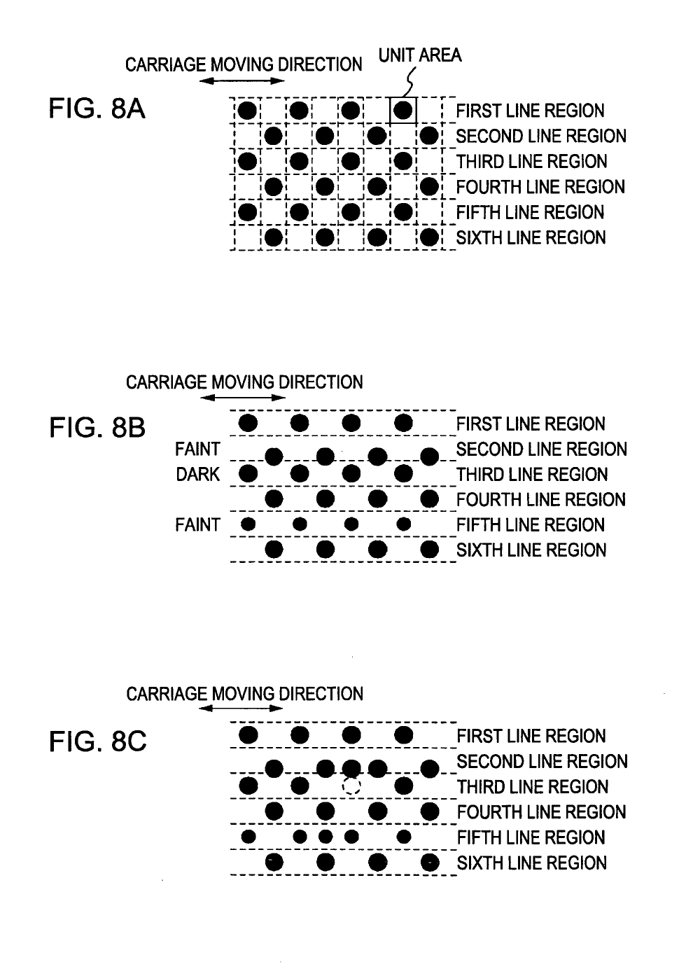

FIG. 8A is a diagram illustrating a state where dots are formed ideally. In the drawing, since the dots are formed ideally, the dots are formed accurately in the unit areas and the raster lines are formed accurately in the line regions. In the drawing, the line region is shown as a region interposed between the dotted lines and has a width of 1/360 inch. An image piece having a concentration corresponding to the coloring of the region is formed in each line region. Here, for the purpose of convenient explanation, it is assumed that an image having such a constant concentration that the dot formation rate is 50% is printed.

FIG. 8B is a diagram illustrating the unevenness in concentration. In the drawing, the unevenness in concentration is generated for a reason related to the nozzles. For example, the raster line formed in the second line region is close to the third line region (upstream in the transport direction), due to the unbalance of the ink droplets ejected from the nozzles in the flying direction. The amount of ink droplets ejected from the nozzle to the fifth line region is small and thus the dots formed in the fifth line region are small.

It is natural that the image pieces having the same concentration should be formed in the line regions, but the unevenness in concentration is generated in the image piece depending on the line regions. For example, the image piece in the second line region is relatively faint and the image piece in the third line region is relatively dark. The image piece in the fifth line region is relatively faint.

Macroscopically viewing a print image including the raster lines, the band-like unevenness in concentration along the moving direction of the carriage is visible. The unevenness in concentration serves as a reason for deteriorating the quality of the print image.

FIG. 8C is a diagram illustrating a state where the unevenness in concentration is corrected to form the dots. Here, gray-scale values of the pixel data (CMYK pixel data) of the pixels corresponding to a line region visible as being dark are corrected to form a faint image piece in the line region. Gray-scale values of the pixel data of the pixels corresponding to a line region visible as being faint are corrected to form a dark image piece in the line region. For example, the gray-scale values of the pixel data of the pixels corresponding to the line regions are corrected so that the dot formation rate of the second line region in the drawing increases, the dot formation rate of the third line region decreases, and the dot formation rate of the fifth line region increases. Accordingly, the dot formation rates of the raster lines of the line regions are changed and the concentrations of the image pieces of the line regions are corrected, thereby suppressing the unevenness in concentration of the entire print image.

Therefore, in this embodiment, the gray-scale values of the pixel data are corrected on the basis of the correction value (BRS correction value (correction value for correcting the unevenness in concentration to be described)) set every line region.

### Unevenness in Concentration Due to Inclination of Head

As described above, to suppress the unevenness in concentration for the reason related to the nozzles, the method of correcting the gray-scale values of the pixel data of the pixels corresponding to the line regions on the basis of the correction value set every line region is effective. However, when the same correction value is uniformly applied to all the pixel data of the pixels corresponding to the line region, the following problem is caused.

That is, when the head 41 moves in the moving direction with the movement of the carriage 31, it is known that there occurs a phenomenon that the head 41 (the carriage 31) is inclined. This phenomenon results from mechanical characteristics of the carriage 31 or peripheral members of the carriage 31. Accordingly, the occurring place (at what position in the moving direction the head 41 is inclined) or the occurrence frequency (there is a printer 1 in which this phenomenon does not occur) of this phenomenon is different depending on the printer 1.

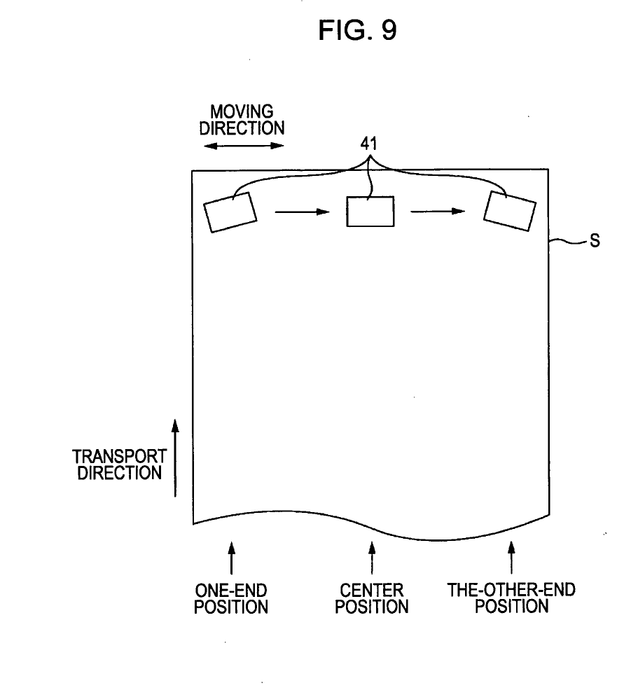

FIG. 9 is a diagram schematically illustrating a state where the relative position of the sheet S to the head 41 is changed when the head 41 of the printer 1 moves in the moving direction relative to the sheet S (the inclination of the head 41 is exaggerated in FIG. 9 for the purpose of easy understanding of the drawing and the actual inclination of the head 41 is small). In the printer 1, as the head 41 inclined to the left at one end in the moving direction moves in the moving direction, the inclination of the head 41 slowly decreases and the inclination almost disappears at the center position in the moving direction. When the head 41 further moves in the moving direction, the head 41 starts its inclination to the right and the inclination of the head 41 slowly increases with the further movement of the head 41 in the moving direction. The inclination of the head to the right is the largest at the other end in the moving direction.

The phenomenon that the head 41 is inclined has an influence on the landing position of the ink droplets ejected from the nozzles onto the sheet S. Accordingly, when the ink is ejected without correcting the unevenness in concentration, the concentrations of the pixels formed in the same line region are different, depending on at what positions in the moving direction the pixels are located. Therefore, even when the same correction value is uniformly applied to all the pixel data of the pixels corresponding to the line region at the time of correcting the unevenness in concentration, the unevenness is not accurately corrected. That is, when the same correction value is uniformly applied to all the pixel data of the pixels corresponding to the line region, the unevenness in concentration due to the nozzles can be suppressed but the unevenness in concentration due to the inclination of the head cannot be suppressed.

Therefore, when the gray-scale values of the pixel data are corrected on the basis of the BRS correction values set every line region to suppress the unevenness in concentration due to the nozzles, it is necessary to consider the suppressing of the unevenness in concentration due to the inclination of the head.

### Error of Reading Position of Scanner

Here, it is assumed that an image is read with a resolution of 720 dpi (in the main scanning direction)×720 dpi (in the sub scanning direction).

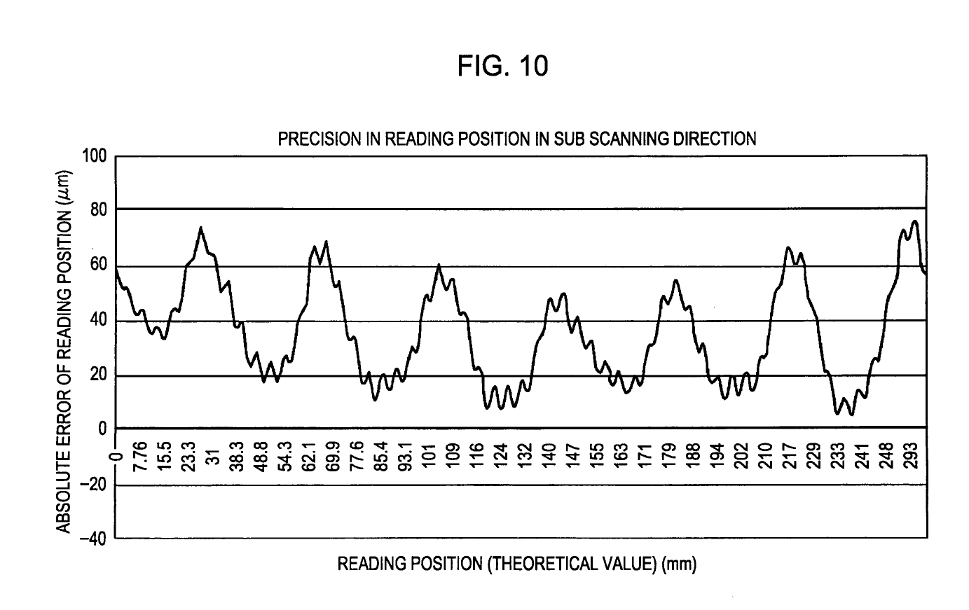

FIG. 10 is a graph illustrating an error of the reading position of the scanner. In the graph, the horizontal axis represents the reading position (theoretical value) (that is, the horizontal axis in the graph represents the position (theoretical value) of the reading carriage 153. The vertical axis in the graph represents an error of the reading position (difference between the theoretical value of the reading position and the actual reading position). In the graph, for example, when the reading carriage 153 is made to move by 1 inch (=25.4 mm), an error of about 60 μm is generated.

When the theoretical value of the reading position and the actual reading position are matched with each other, a pixel apart by 720 pixels in the sub scanning direction from a pixel indicating a reference position (a position at which the reading position is zero) indicates an image at the position accurately apart by 1 inch from the reference position. However, when the error of the reading position shown in the graph is generated, the pixel apart by 720 pixels in the sub scanning direction from the pixel indicating the reference position indicates an image at a position more apart by 60 μm than the position apart by 1 inch from the reference position.

When the slope of the graph is zero, the image is read at an equal interval of 1/720 inch. However, the image is read at an interval greater than 1/720 inch at positions where the slope of the graph is plus. The image is read at an interval smaller than 1/720 inch at positions where the slope of the graph is minus.

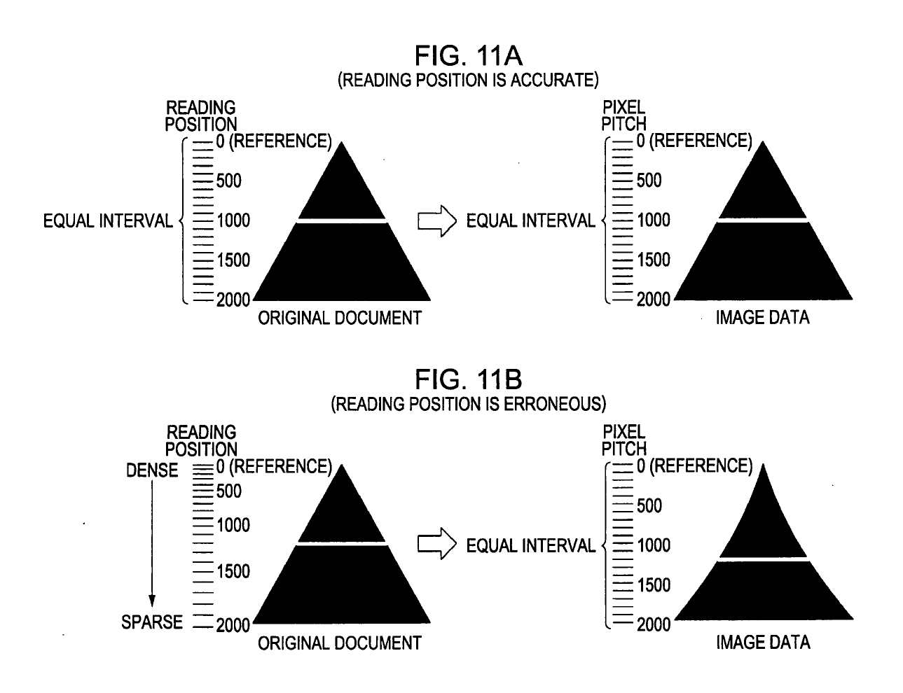

FIG. 11A is a diagram illustrating a relation of the original document and the image data when the reading position of the scanner is accurate. The reading carriage 153 moves relative to the original document in the longitudinal direction in the drawing. The image represented by the image data includes square pixels having a size of 1/720 inch (in the main scanning direction)× 1/720 inch (in the sub scanning direction) arranged in a matrix.

Here, for the purpose of convenient explanation, it is assumed that the original document has a regular triangle having a height of about 2000/720 inch. For the purpose of convenient explanation, a white line is formed at a position of a half height (position apart by 1000/720 inch from the vertex of the regular triangle) of the regular triangle. In the following description, a reference in the sub scanning direction of the reading position is the position of the vertex of the regular triangle and a reference in position of a pixel in the image data is the pixel at the vertex of the regular triangle.

When the reading position of the scanner 150 is accurate, the original document is read at an equal interval whenever the reading carriage 153 moves in the sub scanning direction by 1/720 inch (see the left drawing). The image of the read image data is the same as the image represented by the original document (see the right drawing). The white line in the original document is read by the 1001-st reading operation and is read as the pixel data of the pixel apart by 1000 pixels from the reference pixel.

FIG. 11B is a diagram illustrating a relation of the original document and the image data when the reading position of the scanner has an error. Here, the image is read at an interval (that is, densely) smaller than 1/720 inch at positions close to the reference position and the image is read at an interval (that is, sparsely) greater than 1/720 inch at positions apart from the reference position (see the left drawing). The image of the read image data is deformed from the image represented by the original document (see the right drawing). The image at positions above the white line in the original document is read by the 1001-st reading operation (see the left drawing). The white line in the original document is read by the about 1200-th reading operation (see the left drawing) and is read as the pixel data of the pixel apart by about 1200 pixels from the reference pixel (see the right drawing). As a result, the white line in the image data is located lower than the white line in the original document.

As described later, in this embodiment, a BRS correcting test pattern printed by the printer is read by the scanner at the time of calculating the BRS correction value for correcting the unevenness in concentration. However, when the reading position of the scanner has an error, the BRS correcting test pattern cannot be accurately read and thus the BRS correction value cannot be accurately calculated. Therefore, it is necessary to consider characteristics of the scanner 150 at the time of calculating the BRS correction value on the basis of the image data read by the scanner 150.

### First Embodiment

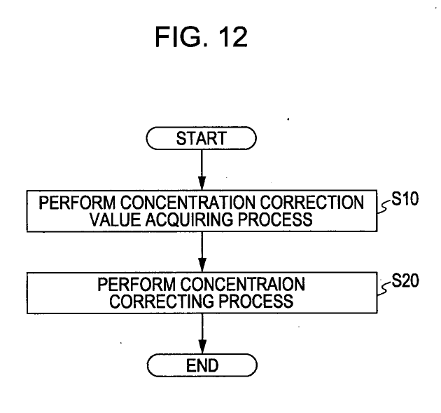

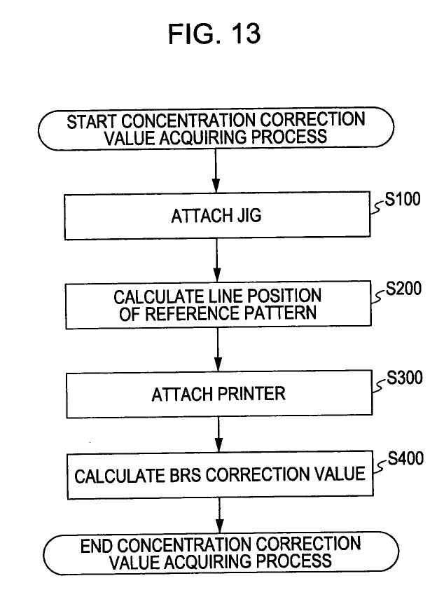

FIGS. 12 and 13 are flow diagrams illustrating the entire flow of a first embodiment of the invention. This flow is roughly divided into a concentration correction value acquiring process (see S10 of FIG. 12 and FIG. 13) performed in an inspection process in a printer manufacturing plant and a concentration correcting process (see S20 of FIG. 12) performed in a printing operation by a user.

In the concentration correction value acquiring process, an inspector first mounts a jig (to be described later) on the scanner 150 (S100). A reference sheet (to be described later) having a reference pattern (to be described later) formed therein is attached to the jig. Then, the computer 110 reads the reference pattern by the use of the scanner 150 and calculates a line position of the reference pattern (S200). The reading result is used in a “BRS correction value calculating process” in S400. The inspector installs the printer 1 to be inspected in the computer 110 (S300, see FIG. 1).

After the installation of the printer 1, the computer 110 performs the BRS correction value calculating process of correcting the unevenness in concentration (S400).

The BRS correction values are stored in the memory 63 of the printer having been inspected. This printer is shipped from the plant and is delivered to the user having purchased the printer. Then, the concentration correcting process is performed on the basis of the BRS correction values when the user prints a print image on a printing medium, thereby obtaining a print result with high image quality.

The concentration correction value acquiring process (S10) and the concentration correcting process (S20) will be described in detail now in this order.

### Concentration Correction Value Acquiring Process

### Mounting of Jig

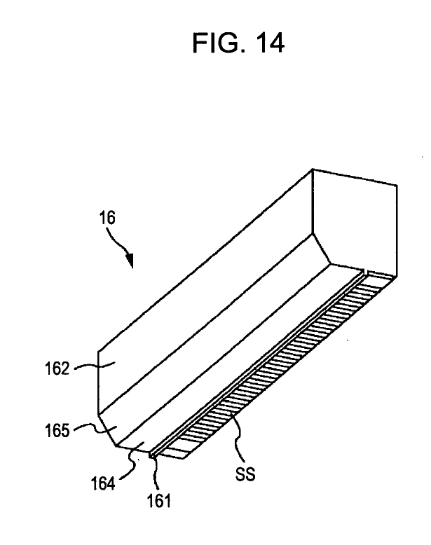

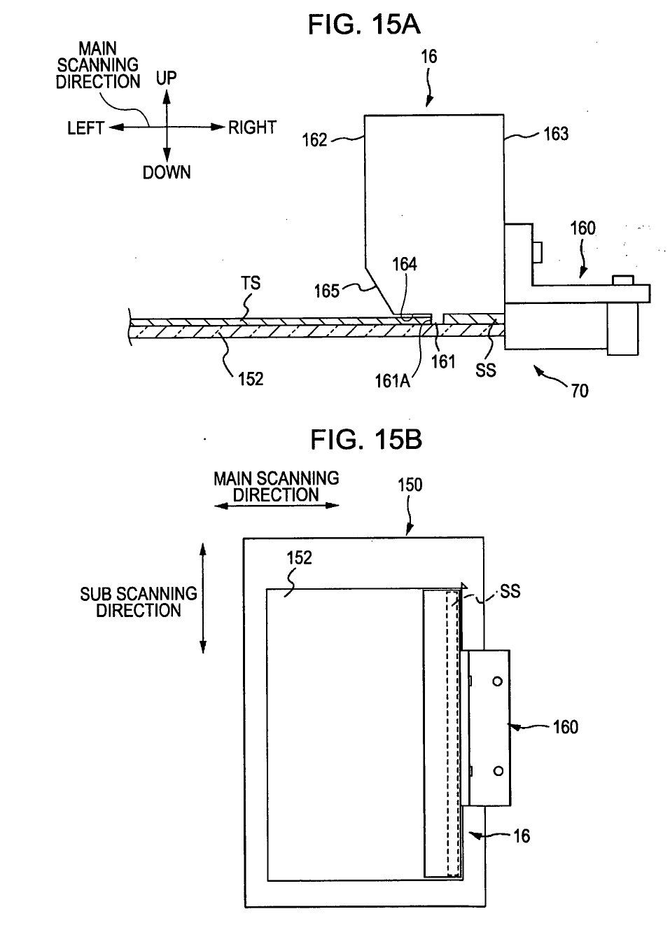

FIG. 14 is a diagram illustrating a jig 16 to be mounted on the scanner 150. FIG. 15A is a diagram illustrating the jig 16 mounted on the scanner 150 as viewed in the sub scanning direction. FIG. 15B is a diagram illustrating the jig 16 mounted on the scanner 150 as viewed from the upside.

The jig 16 serves to position a test sheet TS on the platen glass 152 of the scanner 150. The jig 16 includes a protrusion 161, a side surface 162, a side surface 163, a pressing surface 164, and a slope 165. The jig 16 is mounted on the scanner 150 by a fixing member 160 in a state where the protrusion 161 collides with the platen glass 152. The jig 16 has a longitudinal shape in a direction. The jig 16 is mounted on the scanner 150 so that the longitudinal direction of the jig 16 is parallel to the sub scanning direction of the scanner 150.

The protrusion 161 is disposed along the longitudinal direction of the jig 16. Accordingly, when the jig 16 is mounted on the scanner 150, a collision portion 161A which is one side surface of the protrusion 161 is parallel to the sub scanning direction of the scanner 150. When the jig 16 is mounted on the scanner 150, a gap is formed between the platen glass 152 and the pressing surface 164 due to the protrusion 161.

At the time of setting the test sheet TS on the platen glass 152 (to be described later), the inspector allows a side of the test sheet TS to slide into the gap between the platen glass 152 and the pressing surface 164 and allows the side of the test sheet TS to collide with the collision portion 161A. Accordingly, the side of the test sheet TS is almost parallel to the sub scanning direction. When a side of the test sheet TS collides with the collision portion 161A, the pressing surface 164 presses the test sheet TS from the upside. Accordingly, when the test sheet TS is read by the scanner 150, it is possible to suppress the test sheet TS from rising up from the platen glass 152.

The portion between the side surface 162 and the pressing surface 164 is chamfered to form the slope 165. Regarding the slope 165, when the jig 16 is mounted on the scanner 150, the gap from the platen glass 152 increases by the distance apart from the pressing surface 164 (by the distance apart from the collision portion 161A). Accordingly, when the inspector sets the test sheet TS, it is possible to smoothly insert the test sheet into the gap between the platen glass 152 and the pressing surface 164.

A reference sheet SS is attached to the bottom surface of the jig 16. When the jig 16 is mounted on the scanner 150, the reference sheet SS faces the platen glass 152 and thus the scanner 150 can read the reference sheet.

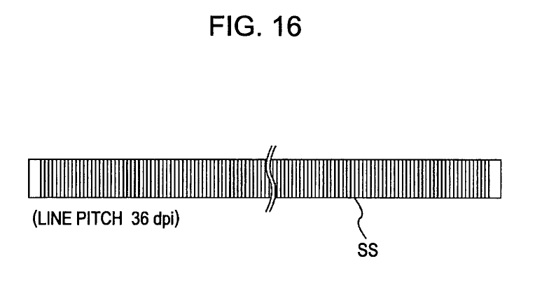

FIG. 16 is a diagram illustrating the reference sheet SS. The size of the reference sheet SS is 10 mm×300 mm and the reference sheet SS has a longitudinal shape. Plural lines are formed as a reference pattern at an interval of 36 dpi ( 1/36 inch) on the reference sheet SS. Since the reference sheet SS is repeatedly used, the reference sheet is formed of a PET film instead of a sheet of paper. The reference pattern is formed with high precision by a laser beam.

When the jig 16 is mounted on the scanner 150, the long side of the reference sheet SS is parallel to the sub scanning direction of the scanner 150, that is, the lines of the reference sheet SS are parallel to the main scanning direction of the scanner 150. Accordingly, the reference sheet SS faces the platen glass 152 all over the platen glass 152 in the sub scanning direction of the scanner 150. When the side of the test sheet TS collides with the collision portion 161A, the side of the test sheet TS is parallel to the long side of the reference sheet SS.

### Reference-Pattern Line Position Calculating Process

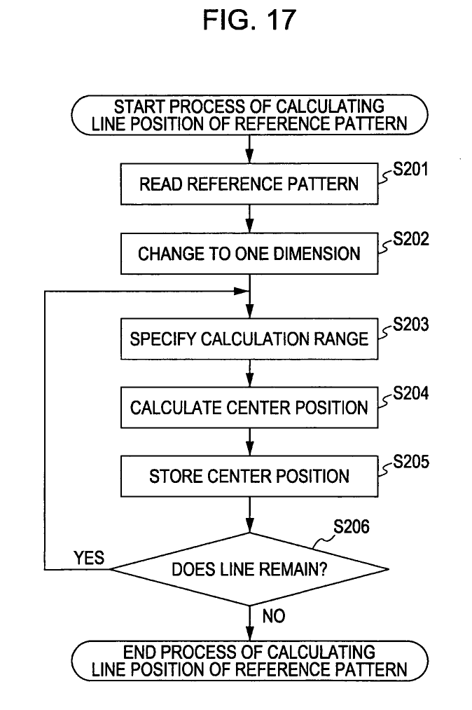

FIG. 17 is a flow diagram illustrating a reference-pattern line position calculating process. This process is carried out by an image processing program installed in the computer 110.

First, the computer 110 allows the scanner 150 to read the reference pattern (S201). The scanner 150 reads the reference sheet SS with a resolution of 2880 dpi (in the main scanning direction)×2880 dpi (in the sub scanning direction) and acquires the image data of the reference pattern. The image data includes pixel data of pixels two-dimensionally arranged in the x direction (direction corresponding to the main scanning direction) and the y direction (direction corresponding to the sub scanning direction). That is, the images of the reference patterns represented by the image data are longitudinal in the y direction and the images of the lines of the reference patterns are parallel to the x direction. The pixel data of the image data is black and white data and has 256 gray-scale values.

Since the reading position of the scanner has an error (see FIG. 10), the reference pattern is read under the influence of the error. Accordingly, the reference patterns of the reference sheet are formed at an equal interval of 36 dpi, but the lines of the reference patterns represented by the image data are not formed at the equal interval and thus are different from the actual reference patterns.

The computer 110 averages the gray-scale values of the pixel data of the pixels arranged in the x direction in the two-dimensional image data. Accordingly, one-dimensional image data in the y direction is generated (S202). The one-dimensional image data includes the pixel data of the pixels arranged in the y direction at 2880 dpi.

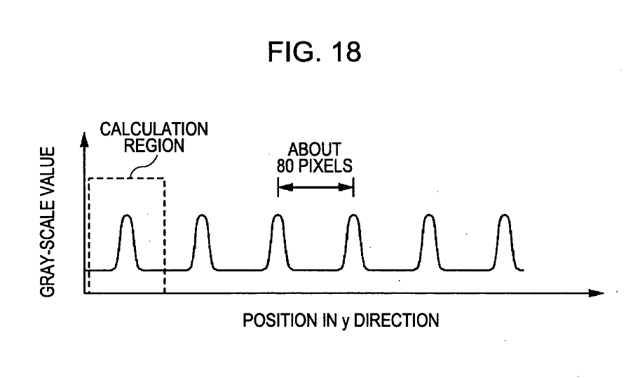

FIG. 18 is a graph illustrating the one-dimensional image data. The vertical axis in the graph represents a gray-scale value and the horizontal axis represents a position of a pixel in the y direction. The position of the first pixel in the y direction is 0 and the position of the pixel in the y direction apart by 100 pixels from the above-mentioned pixel is 100.

Since the reference patterns including the lines at the interval of 36 dpi are read with the resolution of 2880 dpi, the peaks representing the line positions are shown in the graph every about 80 pixels. However, since the reading position of the scanner 150 has an error, the peak interval is not necessarily 80 pixels. Therefore, the computer calculates the line positions in the image data by the use of the processes of S203 to S206.

First, the computer 110 selects as a calculation range of the pixel data of 80 pixels (range in the dotted line in FIG. 18) before and after the first peak (S203).

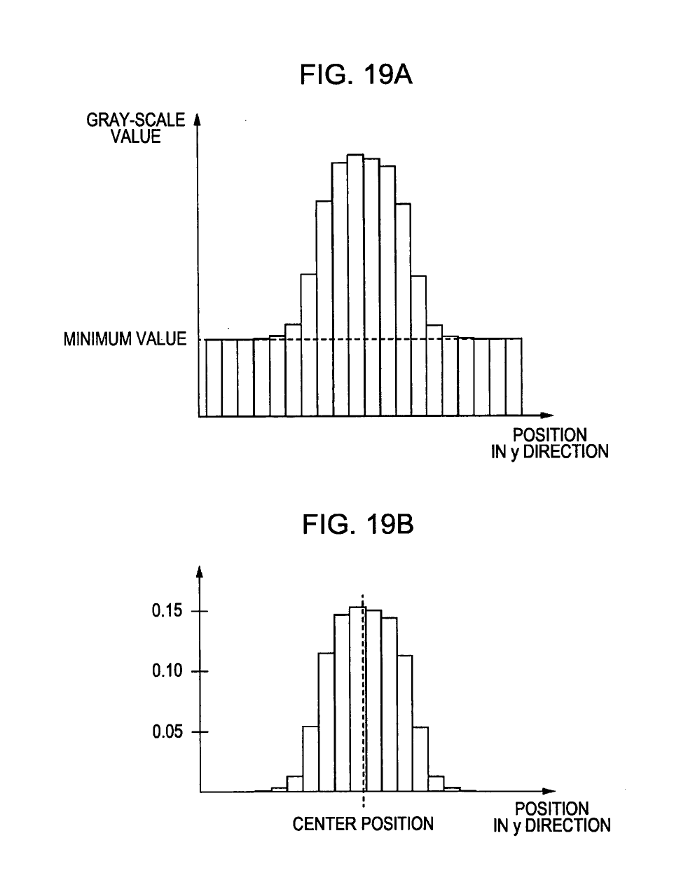

FIG. 19A is a diagram illustrating the pixel data in the calculation range. The image data (gray-scale values) discretely exist at integer positions in the y direction. The computer 110 calculates the minimum value of the pixel data and subtracts the minimum value from the pixel data. Accordingly, the minimum value of the pixel data becomes zero.

Then, the computer normalizes the pixel data (a part of S204). The normalization is implemented by calculating the sum of the gray-scale values of the pixel data of 80 pixels and dividing the gray-scale values of the pixel data by the sum. Accordingly, the sum of the normalized gray-scale values of the pixel data of 80 pixels becomes one.

FIG. 19B is a diagram illustrating the normalized pixel data. The computer 110 calculates the center position of the normalized pixel data as the line position (S204). The center position of the pixel data can be obtained by multiplying the gray-scale value of the pixel data of each pixel by the position in the y direction and calculating the total sum thereof.

The computer 110 stores the calculated center position as the line position (S205). The pixel data corresponds to the integer positions in the y direction, but the center position of the pixel data is not necessarily the integer position. Accordingly, in this embodiment in which the center position of the pixel data is used as the line position, it is possible to calculate the line position in the image data with higher precision than that in the case where the position of the peak pixel in the calculation range is used as the line position.

The computer 110 calculates all the line positions in the pixel data by repeatedly performing the processes of S203 to S205 (S206). A next calculation range is the pixel data of 80 pixels before and after the position apart by 80 pixels from the previously-calculated center position (S203).

When the reading position of the scanner 150 does not have an error, the interval of the calculated line positions is 80 pixels. However, since the reading position actually has an error, the interval of the calculated line positions is not 80 pixels.

However, the calculated line positions are information reflecting the error of the reading position of the scanner 150. Accordingly, the calculated line positions are stored in the computer 110 and are used in the BRS correction value calculating process (S400) to be described later.

### BRS Correction Value Calculating Process

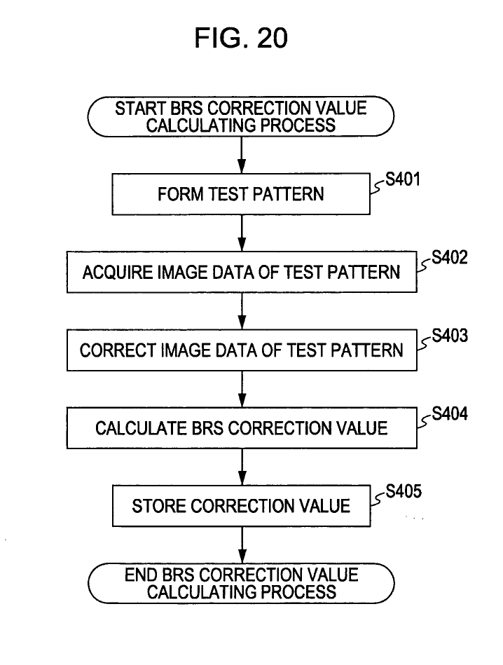

FIG. 20 is a flow diagram illustrating the BRS correction value calculating process. The “BRS correction value” is a correction value for correcting the unevenness in concentration. This, process is carried out by a BRS correcting program installed in the computer 110.

First, the computer 110 transmits print data to the printer 1 and the printer 1 forms (prints) three BRS correcting test patterns on the test sheets TS as an example of a test medium (S401). Then, an inspector sets the test sheet TS in the scanner 150 and acquires the image data of the three test patterns (S402) by allowing the scanner 150 to read the test patterns. The computer 110 corrects the image data of the three test patterns (S403) on the basis of information of the line positions of the reference patterns acquired in S200. The computer 110 performs on the three test patterns a process of calculating the BRS correction value of each line region on the basis of the test patterns (more specifically, on the basis of the corrected image data of the test patterns) and acquires three BRS correction values corresponding to the line region (S404). The computer 110 transmits the correction data to the printer 1 and stores the BRS correction values in the memory 63 of the printer 1 (S405). The BRS correction values stored in the printer reflects the unevenness in concentration of the corresponding printer.

The BRS correction value calculating process will be described now.

### Formation of Test Pattern

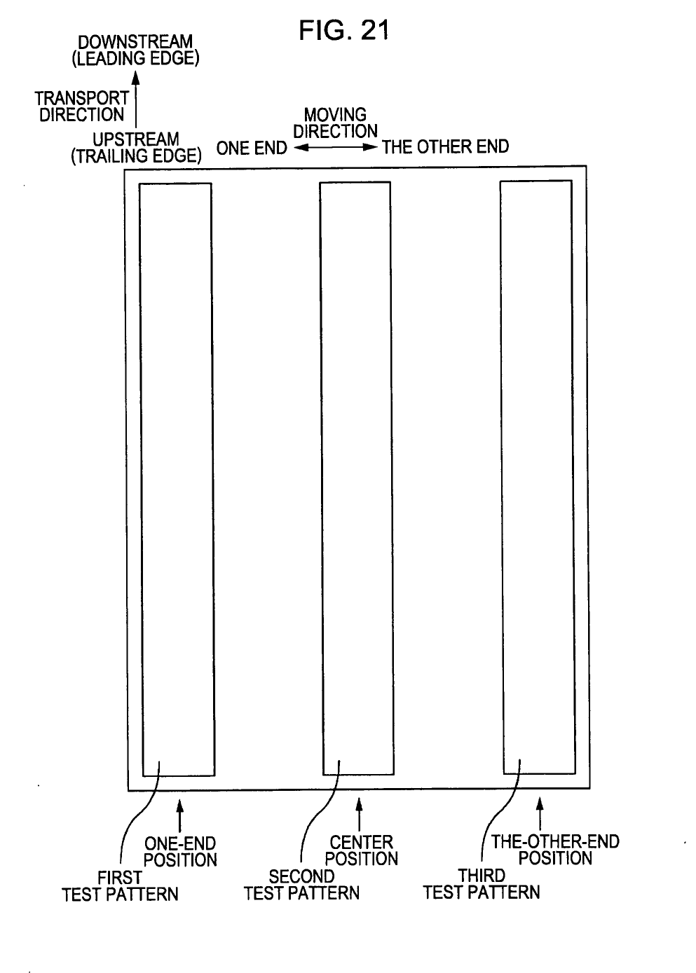

FIG. 21 is a diagram schematically illustrating a state where the test patterns are formed on the test sheet TS. FIG. 22 is a diagram illustrating the test patterns.

Here, N (three in this embodiment) test patterns are formed at different positions in the moving direction by repeatedly performing the dot line forming process (that is, the process of forming a dot line in a line region on a test sheet TS in which plural unit areas are arranged in the moving direction by ejecting ink as an example of the liquid from the nozzles while allowing the nozzles to move in the moving direction) and the transport process (that is, the process of transporting the test sheet TS in the transport direction).

More specifically, as shown in FIG. 21, a first test pattern is formed at one end in the moving direction, a second pattern is formed at a center position in the moving direction, and a third test pattern is formed at the other end in the moving direction.

As shown in FIG. 22, each test pattern includes four sub patterns (of which colors are yellow, magenta, cyan, and black, respectively) having different colors. Each sub pattern includes band-like patterns corresponding to five kinds of concentrations. The respective band-like patterns are formed from image data having a constant gray-scale value. The band-like patterns have gray-scale values of 76 (concentration of 30%), 102 (concentration of 40%), 128 (concentration of 50%), 153 (concentration of 60%), and 179 (concentration of 70%) sequentially from the left band-like pattern and the concentrations thereof are sequentially increase. The five kinds of gray-scale values (concentrations) are called “instructed gray-scale values (instructed concentrations)” and are represented by reference signs Sa (=76), Sb (=102), Sc (=128), Sd (=153), and Se (=179). The test patterns are the same as each other (the arrangement and the arrangement order of the sub patterns or the band-like patterns or instructed gray-scale values of the band-like patterns are not different among the first test pattern, the second test pattern, and the third test pattern) and are different from each other in positions.

In this embodiment, the test patterns are formed by printing the dot lines (raster lines) in the moving direction so that the dot lines (raster lines) are arranged in the transport direction. More specifically, the test patterns are formed by the above-mentioned printing method (the method described with reference to FIGS. 5A and 5B in “Printing Operation of Printer”). That is, the test patterns are formed by repeatedly performing the dot line forming process of forming a dot line in a line region on the test sheet TS by ejecting ink from the nozzle groups while allowing the nozzle groups (carriage 31) of the head 41 to move in the moving direction and the transport process of transporting the test sheet TS in the transport direction by the use of the transport unit 20 to sequentially perform the leading-edge printing operation, the normal printing operation, and the trailing-edge printing operation. As a result, several thousands of dot lines (raster lines) (30 raster lines are formed by the leading-edge printing operation, several thousands of raster lines are formed by the normal printing operation, and 30 raster lines are formed by the trailing-edge printing operation) are arranged from the first dot line (raster line) to the final dot line (raster line) from the uppermost, whereby the test patterns are formed.

The dot line forming process is performed when the nozzle groups of the head 41 (carriage 31) are moving from the left to the right in FIG. 21. With this movement, the dot line constituting the first test pattern is formed in the line region at one end. At the time of forming the dot line constituting the first test pattern, yellow ink is ejected from the yellow ink nozzle group Y to form the dot line (raster line) constituting the yellow sub pattern, and the dot line (raster line) is formed in the order of the dot line (raster line) constituting the magenta sub pattern, the dot line (raster line) constituting the cyan sub pattern, and the dot line (raster line) constituting the black test pattern.

When the nozzle groups of the head 41 (carriage 31) further move, the dot line (raster line) constituting the second test pattern is formed in the line region at the center position and the dot line (raster line) constituting the third test pattern is formed in the line region at the other end. At the time of forming the dot lines constituting the test patterns, similarly to the first test pattern, the dot line (raster line) is formed in the order of the dot line (raster line) constituting the yellow sub pattern, the dot line (raster line) constituting the magenta sub pattern, the dot line (raster line) constituting the cyan sub pattern, and the dot line (raster line) constituting the black test pattern.

When the leading-edge printing operation, the normal printing operation, and the trailing-edge printing operation are sequentially performed by repeatedly performing the dot line forming process and the transport process, three test patterns shown in FIG. 21 are formed.

### Acquisition of Image Data of Test Pattern

After the test patterns are formed, the inspector sets the test sheet TS in the scanner 150. At this time, the inspector brings the entire surface of the test sheet TS into close contact with the platen glass 152 by allowing the side of the test sheet TS to collide with the collision portion 161A of the jig 16 (see FIG. 15A) and allowing another jig to press the portion departing from the jig 16. By setting the test sheet TS using the jig 16, the raster lines of the test patterns are substantially parallel to the main scanning direction and the raster lines are arranged in the sub scanning direction.

The computer 110 allows the scanner 150 to read the three test patterns and acquires the image data thereof. That is, the scanner 150 acquires the image data by allowing the line sensor 158 to read the three test patterns while allowing the line sensor 158 of the scanner 150 to move in the sub scanning direction.

The reading resolution at this time is 2880 dpi (in the main scanning direction)×2880 dpi (in the sub scanning direction) in this embodiment. The image data includes the pixel data of the pixels two-dimensionally arranged in the x direction (direction corresponding to the main scanning direction) and the y direction (direction corresponding to the sub scanning direction). However, when the reading position of the scanner 150 has an error, the lengths of the pixels in the sub scanning direction increase or decrease. As a result, the images of the test patterns represented by the image data are deformed in the sub scanning direction (in the y direction) due to the error of the reading position. The pixel data of the image data has 256 gray-scale values.

Correction of Image data of Test Pattern

First, the computer 110 calculates a “concentration calculating position” on the basis of the information on the line positions of the reference patterns acquired in S200. The “concentration calculating position” represents at what positions the pixels with the interval of 1/2880 inch (equal interval) are located in the image data. Since the line positions of the reference patterns acquired in S200 represent at what positions the actual positions with the interval of 1/36 inch are located in the image data, the concentration calculating position is calculated by dividing the line positions of the reference patterns acquired in S200 by 80. That is, by interpolating the positions of 79 points between the neighboring two lines of the reference patterns acquired in S200, the concentration calculating position is obtained.

When the reading position of the scanner 150 has no error, the interval between the calculated concentration calculating positions is 1 pixel. However, when the reading position of the scanner 150 has an error, the interval between the calculated concentration calculating positions is not 1 pixel. In most cases, the concentration calculating positions are not integers.

The computer 110 calculates the image data corresponding to the concentration calculating positions.

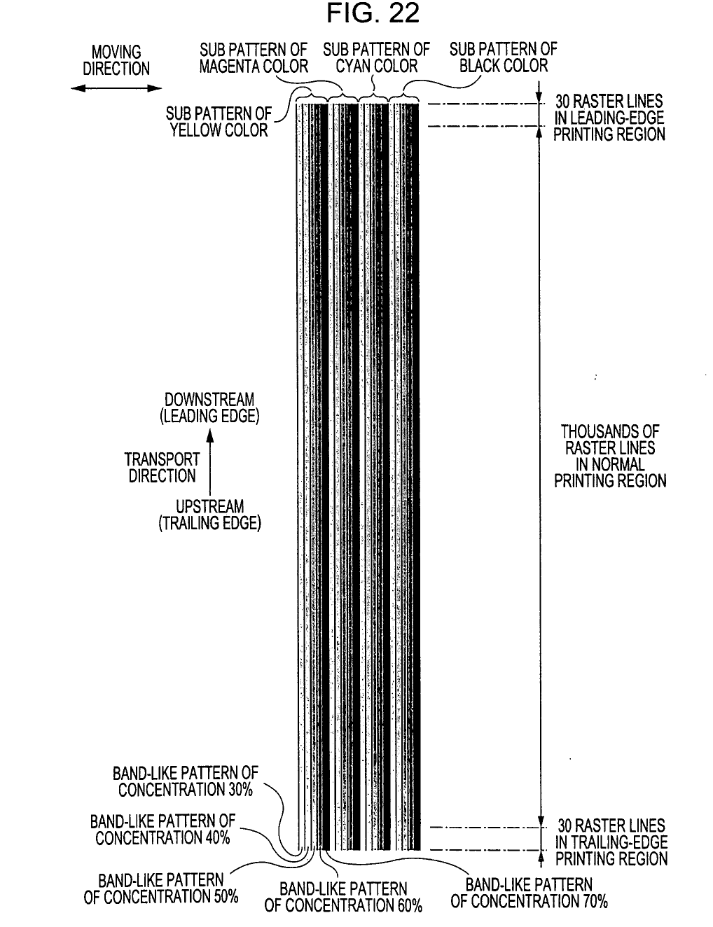

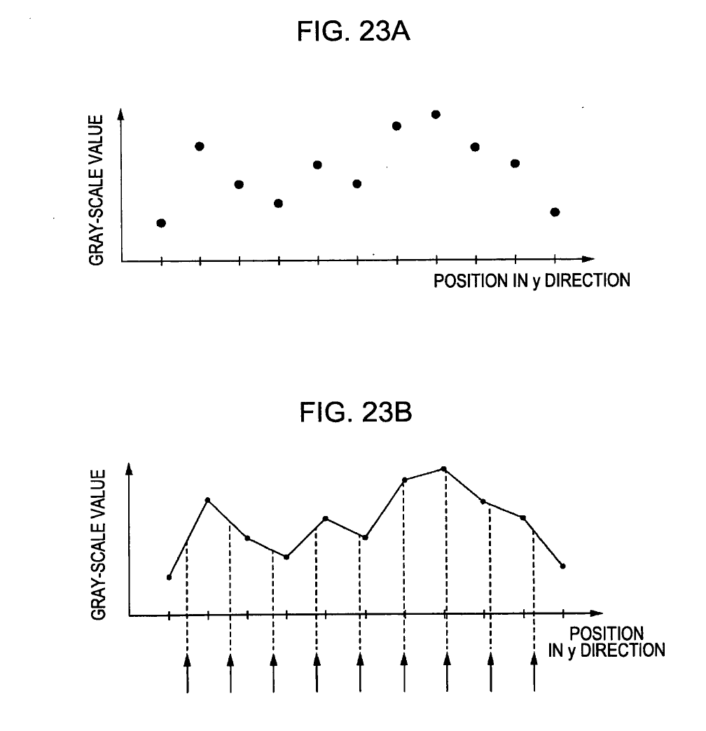

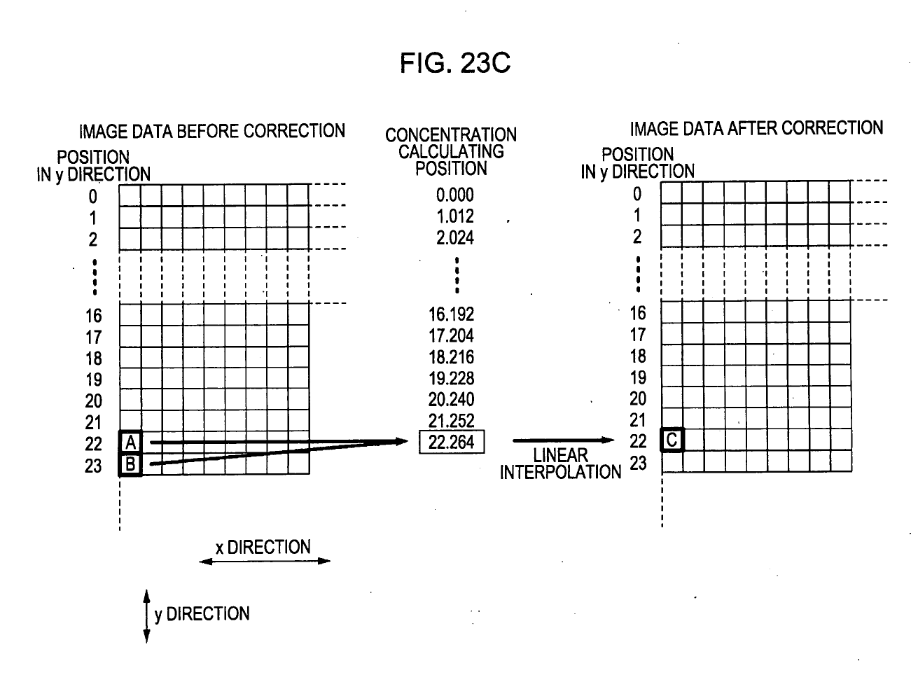

FIG. 23A is a diagram illustrating the pixel data before correction. The horizontal axis in the drawing represents a position in the y direction of a pixel. The scale of the horizontal axis represents the position of an integer in the y direction and represents the positions corresponding to the pixels. The position of the first pixel in the y direction is 0 and the position of the pixel in the y direction apart by 100 pixels from the first pixel is 100. The vertical axis in the drawing represents a gray-scale value represented by the image data. Here, the gray-scale values of the pixel data of the pixels arranged in the y direction of the two-dimensional image data are shown as black round marks which are discrete data.

FIG. 23B is a diagram illustrating a method of calculating the pixel data corresponding to the concentration calculating positions. The positions of the arrows in the drawing represent the concentration calculating positions. As described above, the interval between the concentration calculating positions is not 1 and the concentration calculating positions are not integer, due to the error of the reading position. The computer 110 calculates the gray-scale values corresponding to the concentration calculating positions by linear interpolation.

The image data is corrected so that the gray-scale value of the first concentration calculating position is used as the pixel data of the first pixel in the y direction and the gray-scale value of the n-th concentration calculating position is used as the pixel data of the n-th pixel in the y direction. As a result, the deformation of the image corresponding to the image data in the sub scanning direction (in the y direction) is corrected. That is, the deformation of the image of the test patterns in the sub scanning direction (in the y direction) is corrected.

FIG. 23C is a diagram illustrating the process of calculating the pixel data corresponding to the concentration calculating position. For example, when the 22-th concentration calculating position is “22.264”, the gray-scale value of the concentration calculating position is calculated by linear interpolation on the basis of the pixel data of pixel A of which the position in the y direction is “22” and the pixel data of pixel B of which the position is “23” and the calculated gray-scale value is used as the pixel data of pixel C. The pixel data of the pixel right adjacent to pixel C is calculated by linear interpolation on the basis of the pixel data of the pixel right adjacent to pixel A and the pixel data of the pixel right adjacent to pixel B.

### Calculation of BRS Correction Value

After correcting the image data, the computer 110 performs on three test patterns the process of calculating a RBS correction value every line region on the basis of the test patterns (more specifically, on the basis of the corrected image data of the test patterns) and acquires three (corresponding to the number of test patterns) BRS correction values corresponding to the line region.

First, the computer trims the image of the first test pattern (FIG. 22) in the image data. Then, the computer 110 converts the resolution so that the number of pixels in the y direction of the trimmed image is equal to the number of raster lines constituting the first test pattern. As a result, the line of pixels arranged in the x direction in the image data having been subjected to the conversion of resolution corresponds to the line region. For example, the pixel line in the x direction located at the first line corresponds to the first line region and the pixel line located below corresponds to the second line region.

The computer 110 acquires the concentrations of the five kinds of band-like patterns in the line regions, respectively. Pattern portions having the five kinds of concentrations are included in the respective pixel lines arranged in the x direction. For example, when the concentration of a pattern having a concentration of 30% in a line region is acquired, the computer 110 acquires the gray-scale values of the pixels constituting the image of the pattern of concentration 30% in the pixel line corresponding to the line region.

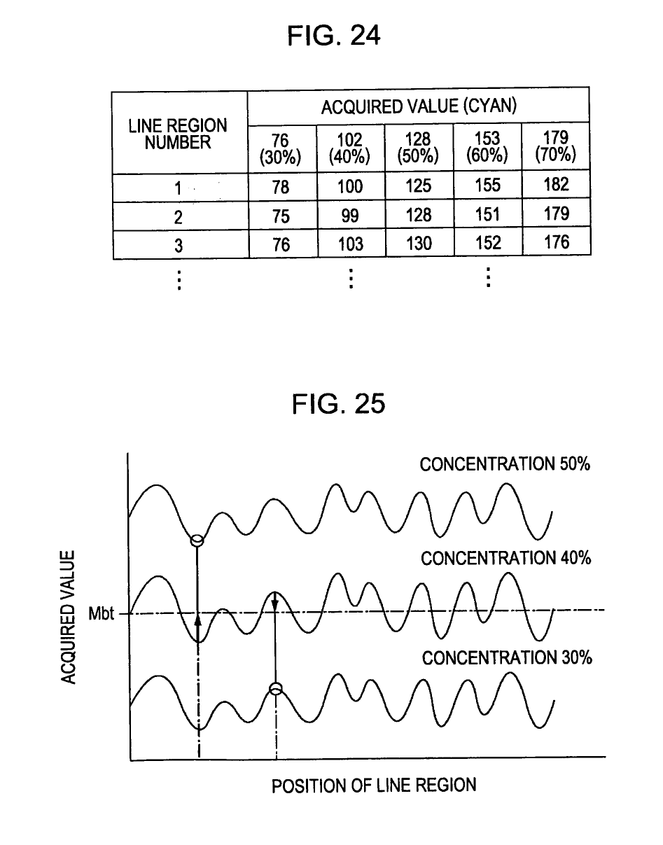

FIG. 24 is a table of acquired values in which the acquisition results of the concentrations of the five kinds of cyan band-like patterns are arranged. In this way, the computer 110 prepares the acquired value table to correspond to the acquired values of the concentrations of the five kinds of band-like patterns every line region. The acquired value table is prepared from the other colors. In the following description, the acquired values of the band-like patterns with the gray-scale values Sa to Se in a certain line region are represented by Ma to Me.

FIG. 25 is a graph illustrating the acquired values of the cyan band-like patterns with concentrations of 30%, 40%, and 50%. The band-like patterns are formed in the same way with the instructed gray-scale values, but brightness and darkness is generated every line region. The difference of brightness and darkness in the line regions causes the unevenness in concentration of a print image.

To remove the unevenness in concentration, it is preferable that the acquired values of the respective band-like patterns are constant. Therefore, a process of making constant the acquired values of the band-like patterns with the gray-scale value Sb (concentration of 40%) will be described now. Here, the average value Cbt of the acquired values of the band-like patterns with the gray-scale value Sb in the entire line regions is determined as a target value of the concentration of 40%. In the line region i of which the acquired values are smaller than the target value Cbt, it is preferable that the gray-scale values are corrected to increase. On the other hand, in the line region j of which the acquired values are greater than the target value Cbt, it is preferable that the gray-scale values are corrected to decrease.

Therefore, the computer 110 calculates the BRS correction values every line region. Here, the process of calculating the BRS correction value for the instructed gray-scale value Sb in a certain line region will be described. As described below, the BRS correction value for the instructed gray-scale value Sb (concentration of 40%) in the line region i in FIG. 25 is calculated on the basis of the acquired values of the gray-value Sb and the gray-scale value Sc (of concentration 50%). On the other hand, the BRS correction value for the instructed gray-scale value Sb in the line region j is calculated on the basis of the acquired values of the gray-scale value Sb and the gray-scale value Sa (of concentration 30%).

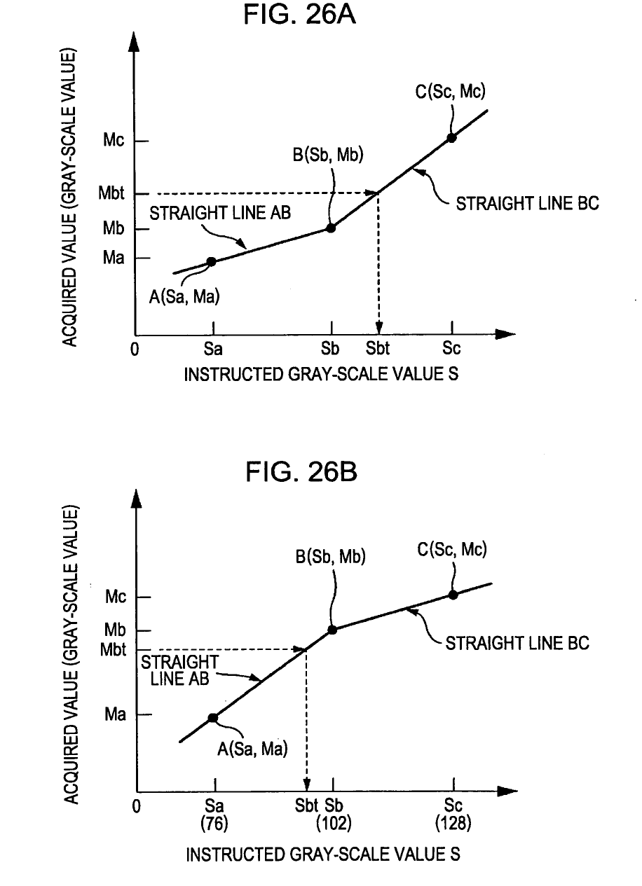

FIG. 26A is a diagram illustrating the target instructed gray-scale value Sbt of the instructed gray-scale value Sb in the line region i. In the line region i, the acquired value Mb of concentration of the band-like pattern formed by the instructed gray-scale value Sb has a gray-scale value smaller than the target value Mbt (the concentration in the line region is fainter than the average concentration). When a concentration pattern of the target value Mbt is formed in the line region by the printer, the printer driver can instruct the correction on the basis of the target instructed gray-scale value Sbt calculated by the following expression (linear interpolation based on the straight line BC).

Sbt=Sb+(Sc−Sb)×{(Mbt−Mb)/(Mc−Mb)}

FIG. 26B is a diagram illustrating the target instructed gray-scale value Sbt for the instructed gray-scale value Sb in the line region j. In the line region j, the acquired value Mb of concentration of the band-like pattern formed by the instructed gray-scale value Sb is a gray-scale value greater than the target value Mbt (the concentration in the line region is darker than the average concentration). When a concentration pattern of the target value Mbt is formed in the line region by the printer, the printer driver can instruct the correction on the basis of the target instructed gray-scale value Sbt calculated by the following expression (linear interpolation based on the straight line BC).

Sbt=Sb−(Sb−Sa)×{(Mbt−Mb)/(Ma−Mb)}

In this way, after calculating the target instructed gray-scale value Sbt, the computer 110 calculates the BRS correction value Hb of the instructed gray-scale value Sb in the line region by the use of the following expression.

Hb=(Sbt−Sb)/Sb

The computer 110 calculates the BRS correction value Hb of the gray-scale value Sb (of concentration 40%) every line region. Similarly, the computer calculates the BRS correction value Hc of the gray-scale value Sc (of concentration 50%) every line region on the basis of the acquired value Mc and the acquired value Mb or Md of the respective line regions. Similarly, the computer calculates the BRS correction value Hd of the gray-scale value Sd (of concentration 60%) every line region on the basis of the acquired value Md and the acquired value Mc or Me of the respective line regions. For the other colors, three BRS correction values Hb, Hc, and Hd are calculated every line region.

Several thousands of raster lines exist in the normal printing region, but regularity exists every seven raster lines. This regularity is considered in calculating the BRS correction values of the normal printing region.

When the computer 110 calculates the BRS correction values in the first line region in the normal printing region (the 31-st line region in the entire printing region), the average value of the acquired values of concentration 30% of the first, eighth, fifteenth, twenty second, twenty ninth, thirty sixth, forty third, fiftieth, . . . line regions is used as the acquired value Ma. Similarly, when the computer 110 calculates the BRS correction values in the first line region in the normal printing region (the 31-st line region in the entire printing region), the average values of the acquired values of concentrations in the first, eighth, fifteenth, twenty second, twenty ninth, thirty sixth, forty third, fiftieth, . . . line regions are used as the acquired values Mb to Me. The BRS correction values Hb, Hc, and Hd of the first line region of the normal printing region are calculated as described above on the basis of the acquired values Ma to Me. In this way, the BRS correction values of the line regions in the normal printing region are calculated on the basis of the average of the acquired values of concentrations of the line regions with a seven interval. As a result, in the normal printing region, the BRS correction values are calculated for only seven line regions of the first to seventh line regions and the BRS correction values of the eighth line region or the line regions subsequent thereto are not calculated. In other words, the BRS correction values of seven line regions of the first to seventh line regions in the normal printing region are used as the BRS correction values of the eighth line region or the line regions subsequent thereto.

The above-mentioned process (that is, the process performed on the first test pattern) is performed on the second test pattern and the third test pattern. As a result, the BRS correction values Hb, Hc, and Hd corresponding to each line region are acquired to correspond to the number of test patterns (three). That is, three values of Hb, Hc, and Hd are acquired every line region.

### Storage of BRS Correction Value

The computer 110 stores the BRS correction values in the memory 63 of the printer 1.

FIG. 27 is a diagram illustrating a cyan BRS correction value table. The BRS correction value table includes three types for the leading-edge printing region, the normal printing region, the trailing-edge printing region. In the respective correction value tables, three (corresponding to the number of test patterns) BRS correction values Hb, Hc, and Hd correspond to each line region (the BRS correction values acquired from the first test pattern are H1b, H1c, and H1d, the BRS correction values acquired from the second test pattern are H2b, H2c, and H2d, and the BRS correction values acquired from the third test pattern are H3b, H3c, and H3d). For example, the BRS correction values Hib_n, Hic_n, and Hid_n correspond to the n-th raster line of the respective line regions. Hib_n, Hic_n, and Hid_n correspond to the instructed gray-scale values Sb (=102), Sc (=128), and Sd (=153), respectively. The same is true in the BRS correction value tables of the other colors.

When it is intended to store the BRS correction values in the memory 63, the positions (hereinafter, also referred to as “moving-direction position”) of the test patterns in the moving direction used to calculate the BRS correction values are also stored in the memory 63. The moving-direction position is used in the concentration correcting process of S20 (details of which will be described later).

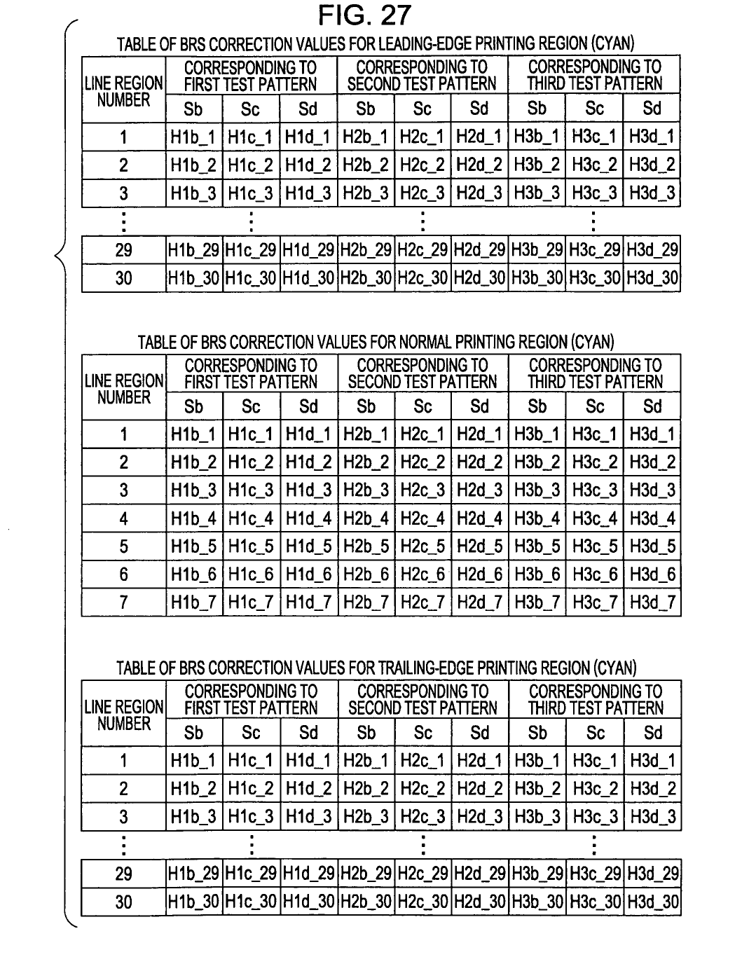

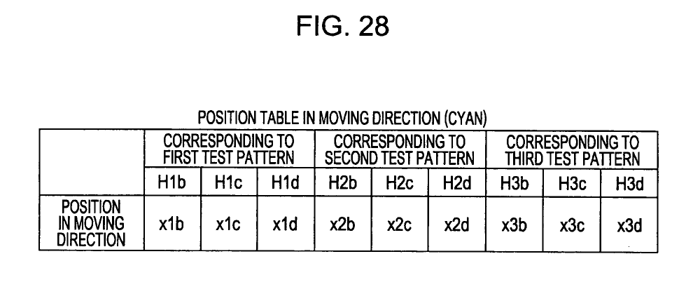

FIG. 28 is a diagram illustrating a cyan moving-direction position table. The moving-direction positions are stored to correspond to the BRS correction values. However, the BRS correction values acquired from different line regions are equal to each other in moving-direction position when the test patterns used to calculate the BRS correction values are equal to each other, and thus the moving-direction position does not exist every line region. For example, the moving-direction positions do not correspond to the BRS correction values H1b_1, H1b_2, H1b_3, . . . , respectively, but only one moving-direction position commonly corresponding to the BRS correction values H1b_1, H1b_2, H1b_3, . . . exists (this moving-direction position is x1b corresponding to the BRS correction value H1b). The BRS correction values calculated from the same test pattern are different in sub patterns or band-like patterns used to calculate the BRS correction values. Therefore, in this embodiment, the moving-direction positions corresponding to the BRS correction values are set as the center positions in the moving direction of the band-like patterns used to calculate the corresponding BRS correction values. For example, the moving-direction position X1b corresponding to the cyan BRS correction value H1b is set as the center position in the moving direction of the band-like pattern of concentration 40% in the cyan sub pattern of the first test pattern.

As shown in FIG. 28, nine moving-direction positions are stored for one color in this way and the number of moving-direction positions to be stored is 36 in total for four colors.

After the BRS correction values and the moving-direction positions are stored in the memory 63 of the printer 1, the concentration correction value acquiring process is ended. Thereafter, the printer 1 is disconnected from the computer 110, the printer 1 is subjected to other inspections, and then the printer 1 is shipped from the plant. The printer 1 is enclosed with a CD-ROM storing the printer driver.

### Concentration Correcting Process

A user having purchased the printer 1 connects the printer 1 to his or her own computer 110 (a computer different from the computer of the printer manufacturing plant). When the enclosed CD-ROM is set to the computer 110, the printer driver is installed in the computer 110. At this time, the printer driver requires the printer 1 for transmitting the correction values and stores the BRS correction values and the moving-direction positions transmitted from the printer in the memory.

The concentration correcting process is performed when the user tries to perform a printing operation on a printing medium such as a sheet of paper. More specifically, when the user gives a print command, the printer driver performs a resolution converting process, a color converting process, a concentration correcting process (S20), a halftone process, and a rasterizing process on the image data output from an application program and generates print data. Then, the printer 1 performs the printing operation on the basis of the generated print data, whereby a print image is printed on the printing medium. The BRS correction values stored in the memory of the computer are used to correct the concentration of a print image, that is, an image (more specifically, the unit areas (pixels) of the image) to be printed on the printing medium by repeatedly performing the dot line forming process and the transport process in the concentration correcting process.

The concentration correcting process will be described in detail now and other processes (such as the resolution converting process, the color converting process, the halftone process, and the rasterizing process) will be described together.

### Processes Before Concentration Correcting Process

The resolution converting process is a process of converting the resolution of image data (text data, image data, and the like) output from an application program into a resolution for printing an image on a sheet of paper. For example, when the resolution for an image on a sheet of paper is specified as 360×360 dpi, the image data received from the application program is converted into image data with the resolution of 360×360 dpi. The image data having been subjected to the resolution converting process is 256 gray-scale data (RGB data) represented in an RGB color space.

The color converting process is a process of converting the RGB data into CMYK data represented in a CMYK color space. In the color converting process, the RGB data of the pixels are converted into the CMYK data corresponding to ink colors. The data having been subjected to the color converting process is 256 gray-scale CMYK data (that is, pixel data by colors) represented in the CMYK color space.

### Concentration Correcting Process

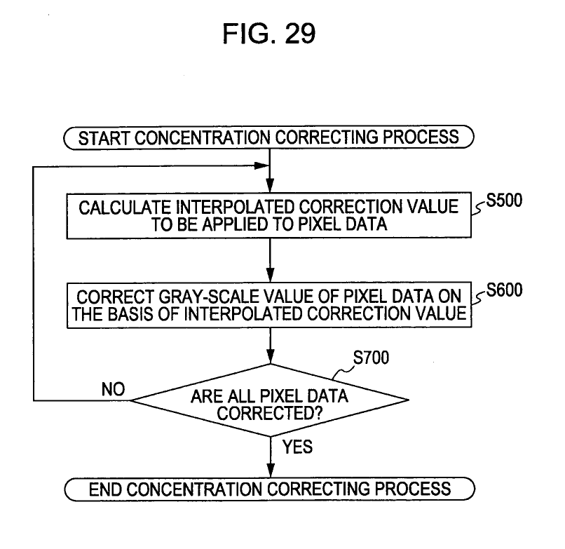

FIG. 29 is a flow diagram illustrating the concentration correcting process. This process is performed by a concentration correcting program of the printer driver.

In this process, the gray-scale values of the pixel data are corrected on the basis of the BRS correction values corresponding to the line regions including the pixel data. For example, when the line region including the pixel data of a unit area is the first line region of the leading-edge printing region, the BRS correction value corresponding to the line region is the BRS correction value (see FIG. 27) of which the line region number is 1 and which is stored in the correction value table for the leading-edge printing region and the gray-scale value of the pixel data of the unit area is corrected on the basis of the BRS correction value of which the line region number is 1. Accordingly, the concentration of the unit area (pixel) of the print image is corrected.

In this way, the gray-scale values of the pixel data are corrected on the basis of the BRS correction values corresponding to the line regions including the pixel data in this process. In this embodiment, the BRS correction value is not uniformly applied to the entire pixel data included in the line region, but first, applied correction values to be applied to the pixel data are calculated by a linear interpolation method on the basis of the BRS correction values (S500). That is, the applied correction value to be applied to the pixel data is calculated for the pixel data included in the same line region. More specifically, an interpolated correction value (applied correction value) is calculated by the linear interpolation method on the basis of the moving-direction positions of two test patterns among N (three in this embodiment) test patterns, two BRS correction values acquired from the two test patterns, and the moving-direction position of the corresponding pixel data. The gray-scale value of the pixel data (concentration of the unit area of the print image) is corrected by the use of the interpolated correction value (applied correction value) (S600). When the processes of S500 and S600 are performed on all the pixel data (all the unit areas of the print image) for each of four colors, the concentration correcting process is ended (S700).

### Interpolated Correction Value Calculating Process

FIG. 30 is a diagram illustrating an interpolated correction value calculating process. This drawing shows a process of calculating the interpolated correction value to be applied to the pixel data included in the n-th line region of the cyan leading-edge printing region. It is assumed that the moving-direction position X of the pixel data is located between the moving-direction position of the first test pattern and the moving-direction position of the second test pattern. The BRS correction values corresponding to the n-th line region of the cyan leading-edge printing region include a value corresponding to the instructed gray-scale value Sb, a value corresponding to the instructed gray-scale value Sc, and a value corresponding to the instructed gray-scale value Sd, and thus the interpolated correction values corresponding to the instructed gray-scale values are calculated as the interpolated correction value. Since the interpolated correction value calculating method does not change due to the change of the instructed gray-scale values, the interpolated correction value calculating process corresponding to the instructed gray-scale value Sb will be described now.

The interpolated correction value (represented by reference sign Gb_n) to be applied to the pixel data is calculated by the linear interpolation method, as shown in FIG. 30, on the basis of the moving-direction positions x1b and x2b of two test patterns (two test patterns of the first and second test patterns having the smallest distance in the moving direction from the pixel data in this embodiment) among the first, second, and third test patterns, two BRS correction values H1b_{—}n and H2b_{—}n acquired from the two test patterns, and the moving-direction position X of the pixel data. That is, the interpolated correction value Gb_n is calculated by the following expression.

Gb_{—}n=H1b_{—}n+(H2b_{—}n−H1b_{—}n)×{(X−x1b)/(x2b−x1b)}

When the interpolated correction value Gc_n corresponding to the instructed gray-scale value Sc and the interpolated correction value Gd_n corresponding to the instructed gray-scale value Sd are calculated in the same way, the interpolated correction value calculating process is ended.

It is preferable that the first test pattern is formed so that the moving-direction position X of any pixel data is not located closer to one end than the moving-direction position x1b of the first pattern (that is, so that X<x1b is not satisfied). When X<x1b is not satisfied, Gb_n can be calculated by a so-called extrapolation method.

### Process of Correcting Gray-Scale Value of Image Data

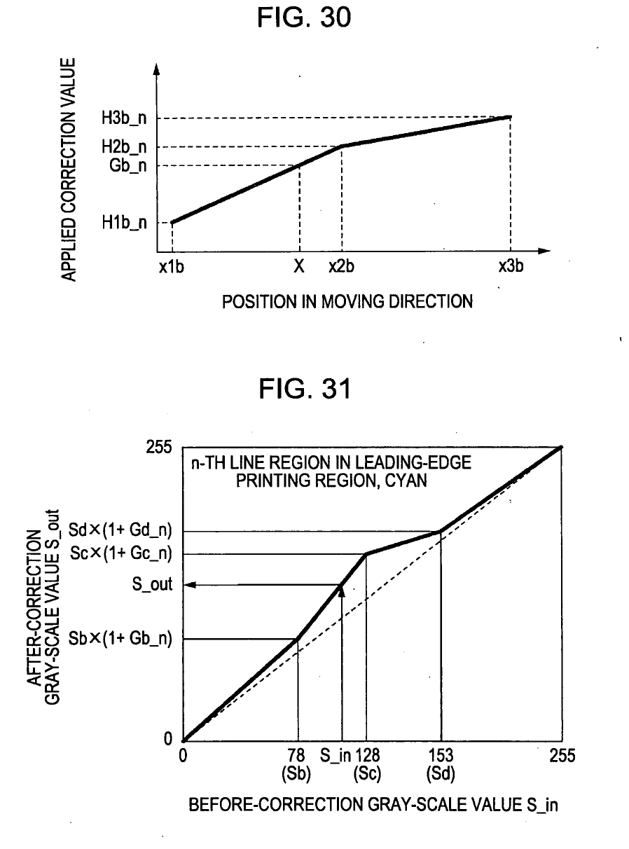

FIG. 31 is a diagram illustrating a gray-scale value correcting process. This drawing shows a process of correcting the gray-scale value S_in of the pixel data (pixel data of which the moving-direction position is X) included in the n-th line region of the cyan leading-edge printing region on the basis of the applied correction value which is the interpolated correction value calculated in S500. The corrected gray-scale value is S_out.

As shown in FIG. 31, when the gray-scale value S_in of the pixel data is equal to the instructed gray-scale value Sb, the gray-scale value S_in is corrected to Sb×(1+Gb_n) using the interpolated correction value Gb_n corresponding to the instructed gray-scale value Sb. Similarly, when the gray-scale values S in of the pixel data are equal to the instructed gray-scale values Sc and Sd, the gray-scale values S_in are corrected to Sc×(1+Gc_n) and Sd×(1+Gd_n) using the interpolated correction values Gc_n and Gd_n corresponding to the instructed gray-scale values Sc and Sd.

On the other hand, when the gray-scale value S_in before correction is different from the instructed gray-scale value, the gray-scale value S_out to be output is calculated by the linear interpolation shown in the drawing. In the linear interpolation shown in the drawing, the values between the corrected gray-scale values S_out (Sb×(1+Gb_n), Sc×(1+Gc_n), and Sd×(1+Gd_n)) corresponding to the instructed gray-scale values Sb, Sc, and Sd are linearly interpolated.

The pixel data of the first to thirtieth line regions of the leading-edge printing region is subjected to the concentration correcting process using the interpolated correction values calculated on the basis of the BRS correction values corresponding to the first to thirtieth line regions stored in the correction value table for the leading-edge printing region.

The pixel data of the first to seventh line regions of the normal printing region (the 31-st to 38-th line regions in the entire printing region) is subjected to the concentration correcting process using the interpolated correction values calculated on the basis of the BRS correction values corresponding to the first to seventh line regions stored in the correction value table for the normal printing region. However, several thousands of line regions exist in the normal printing region, but only the correction values corresponding to seven line regions are stored in the correction value table for the normal printing region. Therefore, the pixel data of the eighth to fourteenth line regions of the normal printing region is subjected to the concentration correcting process using the interpolated correction values calculated on the basis of the BRS correction values corresponding to the first to seventh line regions stored in the correction value table for the normal printing region. In this way, in the line regions of the normal printing regions, the interpolated correction values calculated on the basis of the BRS correction values corresponding to the first to seventh line regions are repeatedly used every seven line regions.

In the trailing-edge printing region, similarly to the leading-edge printing region, the pixel data of the first to thirtieth line regions of the trailing-edge printing region is subjected to the concentration correcting process using the interpolated correction values calculated on the basis of the BRS correction values corresponding to the first to thirtieth line regions stored in the correction value table for the trailing-edge printing region.

### Processes After Concentration Correcting Process

The halftone process is a process of converting high gray-scale data into gray-scale data which can be formed by the printer. For example, the data representing 256 gray scales is converted into 1-bit data representing two gray scales or 2-bit data representing four gray scales by the halftone process. In the halftone process, the pixel data is prepared using a dither method or an error diffusion method so that the printer can distribute and form the dots. The data having been subjected to the halftone process has the same resolution (for example, 360×360 dpi) as the RGB data. The pixel data having been subjected to the halftone process represents the dot forming state. When the pixel data having been subjected to the halftone process is 2-bit data, the pixel data represents no dot, small dot formation, middle dot formation, and large dot formation. In this embodiment, the printer driver performs the halftone process on the pixel data of the gray-scale values corrected by the concentration correcting process.

The rasterizing process is a process of changing the image data in a matrix into a data sequence to be transmitted to the printer. The data having been subjected to the rasterizing process is output to the printer as the pixel data included in the print data.

When the print image is printed on the printing medium by allowing the printer 1 to perform the printing operation on the basis of the generated print data, the concentrations of the unit areas are corrected, thereby suppressing the unevenness in concentration of the entire print image.

### Advantages of Concentration Correcting Method According to First Embodiment

As described in “Related Art” and the like, when the unevenness in concentration (for example, a white line or a black line) is generated in the print image at the time of performing the printing operation with the ink jet printer or the like, the image quality of the print image is deteriorated. Therefore, a method of correcting a concentration of a unit area (pixel) in the print image on the basis of a BRS correction value acquired every dot line (raster line) was suggested as a method for solving the above-mentioned problem. A method of forming a test pattern on a test medium and calculating the BRS correction value every line region on the basis of the test pattern was invented as the method of acquiring the BRS correction value used to correct the concentration of the unit area (pixel) in the print image.

When the above-mentioned ink jet printer is a so-called serial printer, a test pattern is formed by repeatedly performing a dot line forming process of forming dot lines in line regions on a test medium in which plural unit areas (pixels) are arranged in a moving direction by ejecting liquid from nozzles while allowing the nozzles to move in the moving direction and a transport process of transporting the test medium in a transport direction. The concentrations of the unit areas (pixels) in the print image printed on a printing medium by repeatedly performing the dot line forming process and the transport process are corrected on the basis of the BRS correction value acquired from the test pattern. When the concentration is corrected in this way, the concentration might not be accurately corrected. Accordingly, there is a need for a method of accurately correcting a concentration.

More specifically, in the past concentration correcting method (hereinafter, referred to as concentration correcting method according to a comparative example), a single test pattern is formed on a test sheet by repeatedly performing the dot line forming process and the transport process, and the BRS correction value is calculated every line region on the basis of the single test pattern. To correct the concentration of the unit area (pixel) in the print image, the gray-scale value of the pixel data of the pixels corresponding to the line region are corrected on the basis of the BRS correction values set every line region and the same BRS correction value is uniformly applied to all the pixel data of the pixels corresponding to the line region.

In the concentration correcting method according to the comparative example, when the ink jet printer is not a line printer, but a serial printer (in other words, when the test pattern or the print image is formed by repeatedly performing the dot line forming process and the transport process), the following problems are caused.

That is, since the head moves in the moving direction with the movement of the carriage, a phenomenon that the head (carriage) is inclined. As described above, the phenomenon that the head is inclined has an influence on the landing position of the ink droplets ejected from the nozzles onto the sheet. Accordingly, when the ink is ejected without correcting the unevenness in concentration, the concentrations of the pixels formed in the same line region are different, depending on at what positions in the moving direction the pixels are located. Therefore, even when the same correction value is uniformly applied to all the pixel data of the pixels corresponding to the line region at the time of correcting the unevenness in concentration, the unevenness is not accurately corrected. That is, when the same correction value is uniformly applied to all the pixel data of the pixels corresponding to the line region, the unevenness in concentration due to the nozzles can be suppressed but the unevenness in concentration due to the inclination of the head cannot be suppressed.

On the contrary, the concentration correcting method according to this embodiment includes: a test pattern forming step of forming N test patterns at different positions in a moving direction by repeatedly performing a dot line forming process of forming a dot line in a line region on a test sheet in which a plurality of unit areas is arranged in the moving direction by ejecting ink from nozzles while allowing the nozzles to move in the moving direction and a transport process of transporting the test sheet in a transport direction; a concentration correction value acquiring step of performing on the N test patterns a process of calculating a BRS correction value, which is used to correct concentrations of the unit areas in a print image to be printed on a printing medium by repeatedly performing the dot line forming process and the transport process, every line region on the basis of the corresponding test pattern and acquiring N BRS correction values corresponding to each line region; and a concentration correcting step of correcting the concentrations of the unit areas in the print image by the use of interpolated correction values obtained using a linear interpolation method on the basis of positions of two test patterns of the N test patterns in the moving direction, two BRS correcting values acquired from the two test patterns, and positions of the unit areas in the moving direction. That is, in the concentration correcting method according to this embodiment, N test patterns are formed at different positions in the moving direction as shown in FIG. 21, the process of calculating the BRS correction value every line region on the basis of the test pattern is performed on the N test patterns to acquire N BRS correction values corresponding to the line region as shown in FIG. 27, and the concentration of the unit area in the print image is corrected using the interpolated correction value calculated by a linear interpolation method on the basis of the positions in the moving direction of two test patterns among the N test patterns, two BRS correction values acquired from the two test patterns, and the position in the moving direction of the unit area as shown in FIGS. 30 and 31. Accordingly, a correction value suitable for the pixel data of the pixels is applied to the pixel data of the pixels corresponding to the line region and thus it is possible to suppress the unevenness in concentration due to the nozzles and to suppress the unevenness in concentration due to the inclination of the head. Therefore, in the concentration correcting method according to this embodiment, it is possible to accurately correct the concentration, compared with the concentration correcting method according to the comparative example.

### Concentration Correcting Method According to Second Embodiment

Here, a concentration correcting method according to a second embodiment different from the concentration correcting method according to the first embodiment will be described. The second embodiment is different from the first embodiment in only the latter of the concentration correction value acquiring process (S10) and the concentration correcting process (S20) and thus the former is not described.

In the concentration correcting process according to the second embodiment, the gray-scale values of the pixel data are corrected on the basis of the BRS correction values corresponding to the line region including the pixel data and the BRS correction values are not uniformly applied to all the pixel data included in the line region, but an applied correction value suitable for pixel data exists for the pixel data included in the same line region. This is common to the first embodiment.

However, while the applied correction values (interpolated correction values) applied to the pixel data are calculated by the linear interpolation method on the basis of the BRS correction values in the concentration correcting process according to the first embodiment, the applied correction values applied to the pixel data are selected from N BRS correction values in the concentration correcting process according to the second embodiment. In this point, the second embodiment is different from the first embodiment. That is, in the second embodiment, an applied correction value selecting process is performed instead of the interpolated correction value calculating process (S500) in the first embodiment.

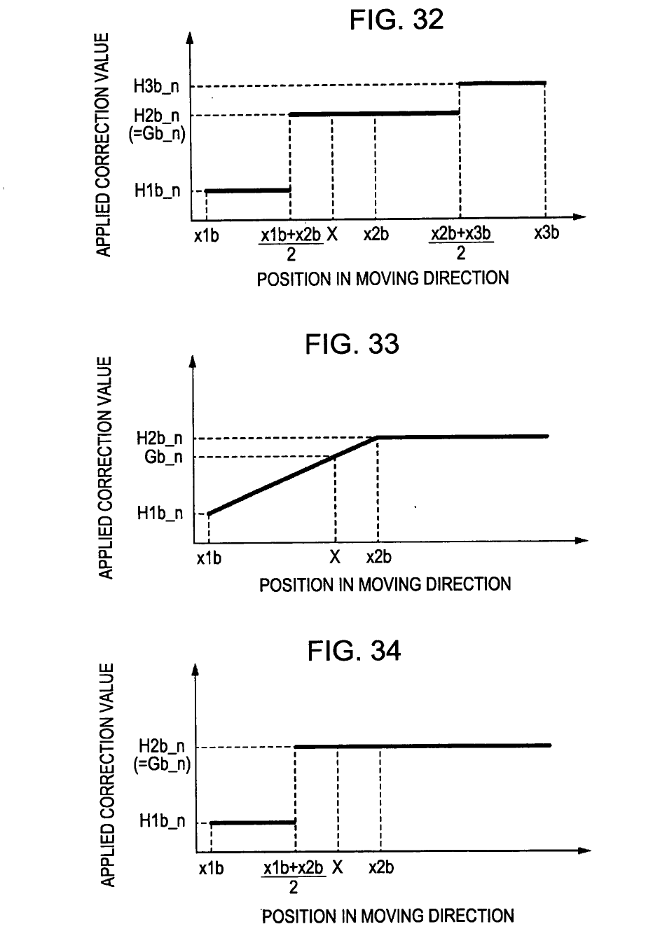

FIG. 32 is a diagram illustrating (the applied correction value selecting process of) the concentration correcting process according to the second embodiment, which corresponds to FIG. 30 of the first embodiment.

As shown in FIG. 32, in the second embodiment, the applied correction value (represented by reference sign Gb_n) applied to the pixel data is the BRS correction value acquired from the test pattern having the smallest distance in the moving direction to the position X of the unit pixel (that is, the moving-direction position of the pixel data) among the N (three) BRS correction values H1b_{—}n, H2b_{—}n, and H3b_{—}n. For example, in FIG. 32, since the test pattern having the smallest distance in the moving direction to the moving-direction position X of the pixel data is the second test pattern (x2b−X is the smallest among X−x1b, x2b−X, and x3b−X), the BRS correction value H2b_{—}n is selected as the applied correction value Gb_n.

When the applied correction value Gc_n corresponding to the instructed gray-scale value Sc and the applied correction value Gd_n corresponding to the instructed gray-scale value Sd are selected, the applied correction value selecting process is ended. When the applied correction value selecting process is ended, the image data gray-scale value correcting process like S600 is performed. That is, the gray-scale value of the pixel data (the concentration of the unit area in the print image) is corrected using the applied correction value selected by the applied correction value selecting process by the same method as S600.

In this way, the concentration correcting method according to the second embodiment includes: a test pattern forming step of forming N test patterns at different positions in a moving direction by repeatedly performing a dot line forming process of forming a dot line in a line region on a test sheet in which a plurality of unit areas is arranged in the moving direction by ejecting ink from nozzles while allowing the nozzles to move in the moving direction and a transport process of transporting the test sheet in a transport direction; a concentration correction value acquiring step of performing on the N test patterns a process of calculating a BRS correction value, which is used to correct concentrations of the unit areas in a print image to be printed on a printing medium by repeatedly performing the dot line forming process and the transport process, every line region on the basis of the corresponding test pattern and acquiring N BRS correction values corresponding to each line region; and a concentration correcting step of correcting the concentrations of the unit areas in the print image by the use of the BRS correction value obtained from the test pattern having the smallest distance to the positions of the unit areas in the moving direction among the N BRS correction values. That is, in the concentration correcting method according to the second embodiment, N test patterns are formed at different positions in the moving direction as shown in FIG. 21, the process of calculating the BRS correction value every line region on the basis of the test pattern is performed on the N test patterns to acquire N BRS correction values corresponding to the line region as shown in FIG. 27, and the concentration of the unit area in the print image is corrected using the BRS correction value acquired from the test pattern having the smallest distance in the moving direction to the position of the unit area among the N BRS correction values as shown in FIGS. 32 and 31. Accordingly, similarly to the concentration correcting method according to the first embodiment, a correction value suitable for the pixel data of the pixels is applied to the pixel data of the pixels corresponding to the line region and thus it is possible to suppress the unevenness in concentration due to the nozzles and to suppress the unevenness in concentration due to the inclination of the head. Therefore, in the concentration correcting method according to the second embodiment, it is possible to accurately correct the concentration, compared with the concentration correcting method according to the comparative example.

In the concentration correcting method according to the second embodiment, similarly to the concentration correcting method according to the first embodiment, the concentration is accurately corrected. However, when both are compared with each other, the concentration correcting method according to the first embodiment is superior in that the accuracy is higher, but the concentration correcting method according to the second embodiment is superior in that the time required for correcting the concentration is reduced because the applied correcting value is not calculated but selected.

### MODIFIED EXAMPLES

In the above-mentioned embodiments (the first embodiment and the second embodiment), the process (that is, the process of correcting the concentration using the interpolated correction value or the selected applied correction value) of forming three test patterns, that is, forming the first test pattern at one end position in the moving direction, the second test pattern at the center position, and the third test pattern at the other end position, and correcting the concentration of the unit area in the print image is performed on all the unit areas of the print image. However, the invention is not limited to the embodiments, but an example (referred to as modified example) where the process is performed on some unit areas of the print image and a process different from the above-mentioned process is performed on the other unit areas may be considered.

A modified example of the first embodiment and a modified example of the second embodiment will be described now.

### Modified Example of First Embodiment

In the modified example of the first embodiment, the process of correcting the concentration of the unit area of the print image is performed on some unit areas of the print image in the concentration correcting step (concentration correcting process). Another concentration correcting step (another concentration correcting process) of correcting the concentration using one of N (three) BRS correction values is performed on the other unit areas of the print image.

This modified example is effective in the following case. That is, as described above, when the head 41 moves in the moving direction with the movement of the carriage 31, it is known that there occurs a phenomenon that the head 41 (the carriage 31) is inclined. This phenomenon results from mechanical characteristics of the carriage 31 or peripheral members of the carriage 31. Accordingly, the occurrence position (at what position in the moving direction the head 41 is inclined) or the occurrence frequency (there is a printer 1 in which this phenomenon does not occur) of this phenomenon is different depending on the printer 1.

Therefore, in an inspection process in a printer manufacturing factory, when the occurrence position of the phenomenon in the printer to be inspected cannot be found out, it is possible to determine whether the concentration should be corrected using the interpolated correction value or the BRS correction value.

For example, it may be found out that the phenomenon occurs at a position closer to one end in the moving direction than the center position (that is, one of the left and right sides in the moving direction) and the phenomenon does not occur at a position closer to the other end in the moving direction (for example, the other of the left and right sides in the moving direction). In this case, since it is necessary to suppress both the unevenness in concentration due to the nozzles and the unevenness in concentration due to the inclination of the head at one end in the moving direction, the concentrations of the unit areas located closer to one end in the moving direction than the center position of the print image is corrected using the interpolated correction value. On the other hand, since only the unevenness in concentration due to the nozzles should be suppressed at the other end in the moving direction, the concentrations of the unit areas located closer to the other end in the moving direction than the center position of the print image are corrected using the BRS correction values acquired from the second test pattern without calculating the interpolated correction value.

FIG. 33 is a diagram illustrating a concentration correcting process according to a modified example of the first embodiment, which corresponds to FIG. 30 of the first embodiment. As shown in FIG. 33, in this modified example, when the moving-direction position X of the pixel data is closer to one end than the moving-direction position x2b of the second test pattern formed at the center position (that is, X<x2b), the applied correction value (represented by reference sign Gb_n) to be applied to the pixel data is an interpolated correction value calculated by a linear interpolation method on the basis of two BRS correction values H1b_{—}n and H2b_{—}n. On the other hand, when the moving-direction position X of the pixel data is closer to the other end than the moving-direction position x2b of the second test pattern formed at the center position (that is, X>x2b), the applied correction value Gb_n to be applied to the pixel data is the BRS correction value H2b_n. The gray-scale values (concentrations of the unit areas of the print image) of the pixel data are corrected using the applied correction value Gb_n.

In this way, according to the modified example of the first embodiment, similarly to the concentration correcting method according to the first embodiment, the concentration is accurately corrected. When both are compared with each other, the concentration correcting method according to the first embodiment is superior in that the accuracy is higher (that is, the concentrations of all the unit areas of the print image are accurately corrected, but the concentration correcting method according to the modified example is superior in simplicity and easiness, because the number of test patterns formed on the test sheet can be reduced (the third test pattern in the first embodiment is not necessary and only the first and second patterns are used in this modified example) and a load for calculating the interpolated correction value can be reduced (the load in this embodiment is half the load in the first embodiment).

### Modified Example of Second Embodiment

A modified example of the second embodiment is based on the same idea as the modified example of the first embodiment. In the modified example of the second embodiment, the first test pattern is formed at one end position in the moving direction and the second test pattern is formed at the center position in the moving direction (the third test pattern is not formed). In the concentration correcting step (concentration correcting process), to suppress both the unevenness in concentration due to the nozzles and the unevenness in concentration due to the inclination of the head, a process of correcting a concentration of a unit area in a print image using a BRS correction value acquired from the test pattern having the smallest distance in the moving direction to the position of the unit area among the first test pattern and the second test pattern is performed on the unit areas located closer to one end in the moving direction than the center position of the print image. On the other hand, to suppress only the unevenness in concentration due to the nozzles, another concentration correcting step (another concentration correcting process) of correcting the concentrations using the BRS correction value acquired from the second test pattern is performed on the unit areas located closer to the other end in the moving direction than the center position of the print image in the modified example of the second embodiment.

FIG. 34 is a diagram illustrating a concentration correcting process according to the modified example of the second embodiment, which corresponds to FIG. 32 of the second embodiment. As shown in FIG. 34, in this modified example, when the moving-direction position X of the pixel data is closer to one end than the moving-direction position x2b of the second test pattern formed at the center position (that is, X<x2b), the applied correction value (represented by reference sign Gb_n) to be applied to the pixel data is the BRS correction value acquired from the test pattern having the smallest distance in the moving direction to the position X of the unit area (that is, the moving-direction position of the pixel data) among N (two) BRS correction values H1b_{—}n and H2b_{—}n. For example, in FIG. 34, since the test pattern having the smallest distance in the moving direction to the moving-direction position x of the pixel data is the second test pattern (x2b−X is smaller than X−x1b), the BRS correction value H2b_{—}n is selected as the applied correction value Gb_n. On the other hand, when the moving-direction position X of the pixel data is closer to the other end than the moving-direction position x2b of the second test pattern formed at the center position (that is, X>x2b), the applied correction value Gb_n to be applied to the pixel data is the BRS correction value H2b_{—}n. The gray-scale values (concentrations of the unit areas of the print image) of the pixel data are corrected using the applied correction value Gb_n.

In this way, according to the modified example of the second embodiment, similarly to the concentration correcting method according to the second embodiment, the concentration is accurately corrected. When both are compared with each other, the concentration correcting method according to the second embodiment is superior in that the accuracy is higher (that is, the concentrations of all the unit areas of the print image are accurately corrected), but the concentration correcting method according to the modified example is superior in simplicity and easiness, because the number of test patterns formed on the test sheet can be reduced (the third test pattern in the first embodiment is not necessary and only the first and second patterns are used in this modified example) and a load for selecting the applied correction value can be reduced (the load in this modified is half the load in the first embodiment).

### Other Embodiments

The above-embodiments are applied to a printer, but the discloses of a printing apparatus, a recording apparatus, a liquid ejecting apparatus, a printing method, a recording method, a liquid ejecting method, a printing system, a recording system, a computer system, a program, and a storage medium storing a program are included therein.

Although the printer, etc. has been described in an embodiment, the embodiment is intended to easily understand the invention, but is not intended to definitely analyze the invention. It is needless to say that the invention can be modified and improved without departing from the gist thereof and includes equivalents thereof.

Although the ink jet printer ejecting ink as an example of the liquid has been described in the above-mentioned embodiments, the invention is not limited to the ink jet printer, but may be applied to a liquid ejecting apparatus ejecting liquid other than the ink. For example, the invention can be applied to a cloth printing apparatus printing an image on a fabric, a color filter manufacturing apparatus or a display manufacturing apparatus manufacturing an organic EL display or the like, a DNA chip manufacturing apparatus manufacturing a DNA chip by applying a DNA solution on a chip, and a circuit board manufacturing apparatus.

What is claimed is:

1. A concentration correcting method comprising:
forming N test patterns at different positions in a moving direction by repeatedly performing a dot line forming process of forming a dot line in a line region on a test medium in which a plurality of unit areas is arranged in the moving direction by ejecting liquid from nozzles while allowing the nozzles to move in the moving direction and a transport process of transporting the test medium in a transport direction;
performing on the N test patterns a process of calculating a concentration correction value, which is used to correct concentrations of the unit areas in a print image to be printed on a printing medium by repeatedly performing the dot line forming process and the transport process, every line region on the basis of the corresponding test pattern and acquiring N concentration correction values corresponding to each line region; and
correcting the concentrations of the unit areas in the print image by the use of interpolated correction values obtained using a linear interpolation method on the basis of positions of two test patterns of the N test patterns in the moving direction, two concentration correcting values acquired from the two test patterns, and positions of the unit areas in the moving direction.

2. A concentration correcting method comprising:
forming N test patterns at different positions in a moving direction by repeatedly performing a dot line forming process of forming a dot line in a line region on a test medium in which a plurality of unit areas is arranged in the moving direction by ejecting liquid from nozzles while allowing the nozzles to move in the moving direction and a transport process of transporting the test medium in a transport direction;
performing on the N test patterns a process of calculating a concentration correction value, which is used to correct concentrations of the unit areas in a print image to be printed on a printing medium by repeatedly performing the dot line forming process and the transport process, every line region on the basis of the corresponding test pattern and acquiring N concentration correction values corresponding to each line region; and
correcting the concentrations of the unit areas in the print image by the use of the concentration correction value obtained from the test pattern having the smallest distance to the positions of the unit areas in the moving direction among the N concentration correction values.

3. The concentration correcting method according to claim 1, wherein the N test patterns include three test patterns of a first test pattern formed at one end in the moving direction, a second test pattern formed at a center position in the moving direction, and a third test pattern formed at the other end in the moving direction, and
wherein the correcting of the concentrations includes performing a process of correcting the concentrations of the unit areas in the print image on all the unit areas of the print image.

4. The concentration correcting method according to claim 1, wherein the correcting of the concentrations includes:
performing a process of correcting the concentrations of the unit areas in the print image using the interpolated correction values on some unit areas of the print image; and
correcting the concentrations of the other unit areas of the print image by the use of one of the N concentration correction values.

5. The concentration correcting method according to claim 2, wherein the N test patterns include two test patterns of a first test pattern formed at one end in the moving direction and a second test pattern formed at a center position in the moving direction, and
wherein the correcting of the concentrations includes:
performing a process of correcting the concentrations of the unit areas in the print image by the use of the concentration correction values, which are obtained from the test pattern having the smallest distance to the positions of the unit areas in the moving direction, on the unit areas located closer to one end in the moving direction than the center position of the print image; and
correcting the concentrations of the unit areas located closer to the other end in the moving direction than the center position of the print image by the use of the concentration correction values obtained from the second test pattern.

6. A printing apparatus storing a concentration correction value which is obtained by:
forming N test patterns at different positions in a moving direction by repeatedly performing a dot line forming process of forming a dot line in a line region on a test medium in which a plurality of unit areas is arranged in the moving direction by ejecting liquid from nozzles while allowing the nozzles to move in the moving direction and a transport process of transporting the test medium in a transport direction; and
performing on the N test patterns a process of calculating a concentration correction value, which is used to correct concentrations of the unit areas in a print image to be printed on a printing medium by repeatedly performing the dot line forming process and the transport process, every line region on the basis of the corresponding test pattern and acquiring N concentration correction values corresponding to each line region,
wherein the printing apparatus corrects the concentrations of the unit areas in the print image by the use of interpolated correction values obtained using a linear interpolation method on the basis of positions of two test patterns of the N test patterns in the moving direction, two concentration correcting values acquired from the two test patterns, and positions of the unit areas in the moving direction and prints the corrected print image on the printing medium.
